(19) United States
(12) Patent Application Publication
(10) Pub. No.: US 2001/0034701 A1
(43) Pub. Date: Oct. 25, 2001

(54) Business process and system for managing and tracking loan collateral

(76) Inventors: Adam F. Fox, Arlington, VA (US); Dan M. Hayes, Alexandria, VA (US)

Correspondence Address: GARDNER, CARTON & DOUGLAS, 321 N. CLARK STREET, SUITE 3400, CHICAGO, IL, 60610, US

(21) Appl. No.: 09/795,178

(22) Filed: Feb. 28, 2001

Related U.S. Application Data
(60) Provisional application No. 60/185,252, filed on Feb. 29, 2000.

(51) Int. Cl. G06F 17/60

(52) U.S. Cl. 705/38

(57) ABSTRACT

The invention provides a financial information management system and business process designed to perform property servicing of commercial loans. The TRACS™ application is a computer database management system that includes a comprehensive central data repository and software applications that provide users with a common interface to established business operations. The primary function of the TRACS™ application is to warehouse operating data on individual properties and report operating data in conjunction with the administration of commercial and multi-family real estate loans. In the preferred embodiment, the TRACS™ application serves as an enterprise-wide system providing operating statement data entry services, portfolio management and analysis tools, loan compliance tracking and CMSA industry standard reporting. In the preferred embodiment, the TRACS™ application is comprised of two database servers that maintain loan information, property financial statements and performs report production. Users can add, modify, delete or send queries to the database servers consistent with their role in the transaction.

### FIELD OF THE INVENTION

The present invention relates generally to computer database systems for managing a plurality of financial accounts. More particularly, the present invention relates to a financial information management system or business information system designed to perform property servicing of commercial mortgage loans.

### BACKGROUND OF THE INVENTION

Computer database management systems are widely used in both standalone computer systems as well as client-server distributed computer systems. Database application programs operate by retrieving data from the database management system, performing modifications on the data and returning the data to the database management system. Database management systems are accessed through interface functions that control the manner in which data is accessed. In the commercial loan property servicing industry, a financial institution may service a large number of accounts. In an effort to deal with these large customer databases, financial institutions maintain these records on multiple-user databases. Therefore, each department has a program that maintains these records. The problem is that information must be extensively duplicated and thus over time, maintaining database system performance becomes a challenge.

U.S. Pat. No. 5,966,695 (Melchione et al.) discloses an electronic sales and service support system and method for identifying sales targets using a centralized database to improve marketing success. The system includes a central database that receives comprehensive information from a variety of internal and external feeds, and standardizes and categorizes information in a three-level hierarchy (households, customer, and accounts) for use by a financial institution. The comprehensive information stored on the central database is accessed through micromarketing workstations to generate lists of sales leads for marketing. A database engine is provided for generating logical access paths for accessing data on the central database to increase speed and efficiency of the central database. The system distributes sales leads electronically to branch networks, where the sales leads are used to target customers for marketing campaigns. The central database is accessed by workstations of a central customer information system for profiling customers enhancing customer relationships with the financial institution, and electronically tracking sales performance during marketing campaigns.

U.S. Pat. No. 5,930,794 (Linenbach) discloses a deferred transaction mechanism that facilitates multi-threaded operation of database application programs, the deferred transaction mechanism allows data items to be committed from the local memory of a computer system to a database system in a background thread, while other foreground threads continue to read the data item. In most instances, this makes the delay in committing a data item to the database imperceptible to a user of a database application program. The deferred transaction mechanism further supports an “undo” feature that allows modifications to a data item located in the computer's local memory to be rapidly discarded.

U.S. Pat. No. 5,875,437 (Atkins) and U.S. Pat. No. 5,644,727 (Atkins) disclose a communication and computer based system and method for effecting exchange, investment and borrowing involving the use of digital communication and computation terminals distributed to users and service providers. Through the system described and its combined computer and communication terminals, client/customers may purchase goods and services, save, invest, track bonuses and rebates and effect enhanced personal financial analysis, planning, management and record keeping with less effort and increased convenience Through a prioritization function, the client specifies her financial objectives, her risk preference, and budgetary constraints The prioritization function automatically suggests to the individual a portfolio of asset and liability accounts that may be credited and/or debited to provide the required funds for consumption and to form investments and borrowing to best realize her financial objectives over defined time horizon. The client's accounts are monitored via a borrowing power baseline, and considered imbalanced if the client's borrowing power is less than the minimum borrowing power. If the account is imbalanced, the client may reallocate the assets and liabilities within the client account and/or modify a set of constraints on the client account. If the client account is still not balanced after modification of the account, the system will deny authorization for certain requested transactions, and may initiate the liquidation of certain asset accounts and reduce the balances of one or more liability accounts.

U.S. Pat. No. 5,617,567 (Doktor) discloses a relationship processing computing system providing for the recording and extraction of entities and for development data representing a queried relationship between entities. The set of entities and relationships may be expanded at any time during the life of the system without reprogramming or compiling computer code and without disrupting concurrent use of the system. Complex inquiries, normally requiring multiple nested queries, may be performed without code level programming.

The problem in the above systems and methods for assembling financial information and retrieving the information is that they lack simplicity, flexibility and speed in accessing and retrieving data. Accordingly, it would be advantageous to provide a system and business process for performing property servicing from a commercial loan aspect that integrates various independent databases and provides users with a common interface to established business operations.

This advantage is achieved in an embodiment of the present invention in which relational database servers maintain a database of information Authorized users can search and modify the existing database consistent with their role in the transaction, by requests to the server from a user device identified with their role.

### SUMMARY OF INVENTION

The present invention provides a business process and system for effecting an improved financial information management system. In a preferred embodiment, the present invention provides a financial information management system that manages and tracks loan collateral.

In another embodiment, the present invention provides a financial information management system designed to manage a plurality of financial accounts relating to property and financial information used in the servicing of commercial mortgage loans.

And yet a further embodiment of the present invention provides a financial information management system that generates portfolio and administrative reports.

The present invention relates generally to a system and business process that streamlines the way information is entered and retrieved. Specifically, the present invention simplifies the process for entering loan information in order to establish a relationship between properties, borrowers and loans, tracks property financial statements and produces reports. The reports generated support the Commercial Mortgage Securities Association (CMSA) reporting requirements, borrower/property correspondence and internal reports pertaining to property and financial statement management.

The central database of the system (hereinafter, the TRACS™ application) underlies all of the applications of the present invention. The TRACS™ application is structured to facilitate the efficient management of property servicing information. The central database provides information to internal databases. The internal databases include several components that support the operations of the present invention. Information from the internal databases is directly accessible from client workstations. The client workstations allow the users to manipulate data to select internal databases. The TRACS™ application is a workflow-based application tailored to the needs of servicing commercial mortgage loans. The TRACS™ application serves as an enterprise-wide system providing operating statement data entry services, portfolio management and analysis tools, loan compliance tracking and industry standard reporting. The system of the present invention provides a comprehensive central data repository and software applications that provide users with a common interface to established business operations. In the preferred embodiment, the TRACS™ application is comprised of two database servers that maintain loan information, property financial statements and perform report production. Authorized users can search and modify the existing database consistent with their role in the transaction by a user device identified with their role.

The TRACS™ application supports property servicing activities such as operating statement analysis, property inspections, special servicing and assumptions processing, reserve processing and contact management. The TRACS™ application tracks assets that are commercial real estate properties. Tracking information for a property includes its physical attributes as well as its inspection history and its financial operating history. The primary function of the TRACS™ application is to warehouse operating data on individual properties and report operating data in conjunction with the administration of commercial, multi-family real estate loans, non-commercial and single-family loans. The TRACS™ application promotes common operating statement analysis across loan portfolios.

### BRIEF DESCRIPTION OF THE DRAWINGS

The present invention will become more clearly appreciated as the disclosure of the present invention is made with reference to the accompanying drawings wherein:

FIG. 1 is a schematic view of the present invention data flow.

FIG. 1a is an illustration of the basic data flow of the present invention.

FIG. 2 is an architecture diagram of TRACS based on Standard Microsoft Windows DNA.

FIG. 3 illustrates an example of the MTS Executant Flow.

FIG. 4 illustrates the TRACS Main Object Hierarchy.

FIG. 5 illustrates the TRACS User Hierarchy.

FIGS. 6-13 illustrates various graphical user interface displays illustrating the Presentation Services Tier components.

### DETAILED DESCRIPTION OF THE INVENTION

The invention will now be described in detail with regard to the best mode and the preferred embodiment.

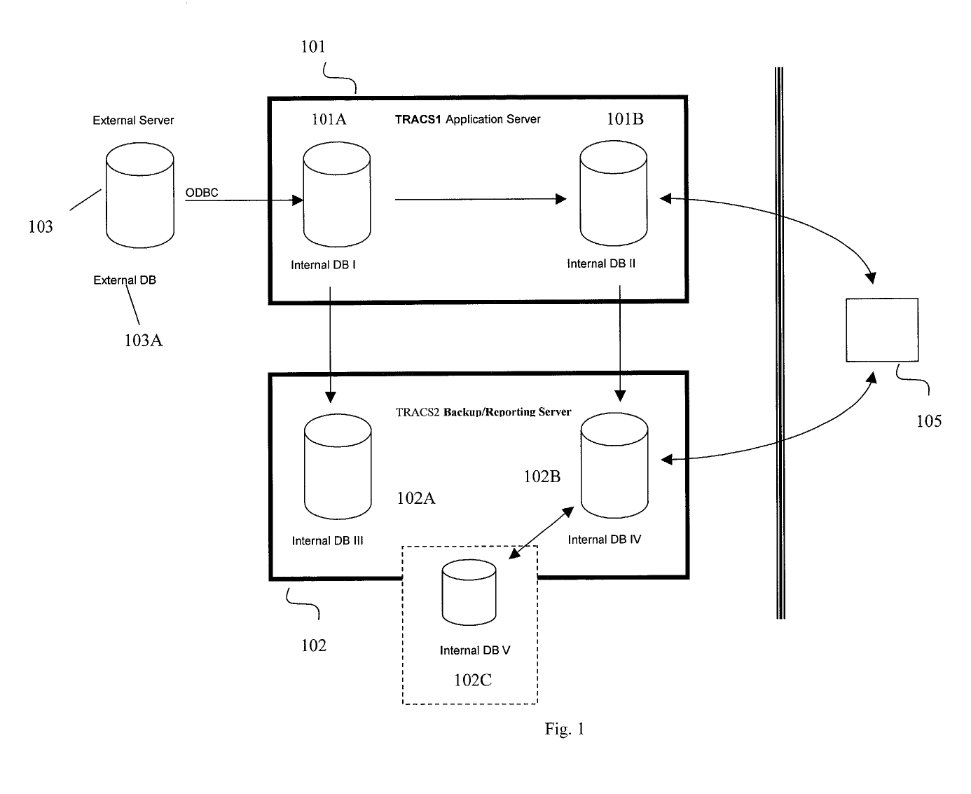

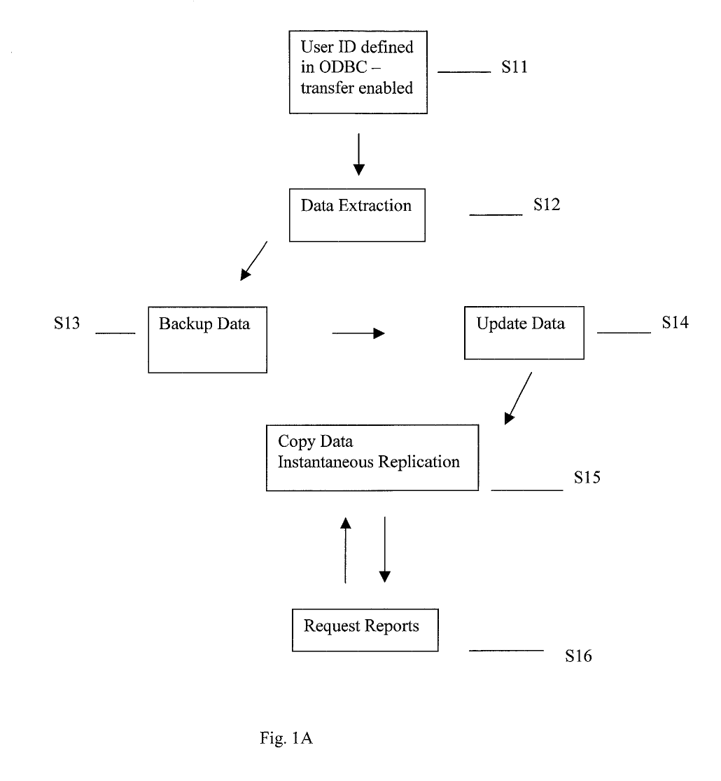

FIG. 1 provides an overview of the system of the present invention. In a preferred embodiment, the system includes an External Server 103 that houses an External database 103A and two Structured Query Language (SQL) relational databases; the TRACS1 application server 101 and the TRACS2 reporting and backup server 102. TRACS1 101 is the main production server. TRACS2 102 is the report processing server and backup server to TRACS1 101. There are two major sources that supply information for the TRACS™ application. The External Server 103 manages collateral and loan servicing information. The External Server 103 is a comprehensive database that includes information about new loan originations and property acquisitions. This information is connected through an Open DataBase Connectivity (ODBC) connection to the TRACS1 application server 101. The second source of information is the information entered into a client workstation 105. Information is constantly exchanged to and from the TRACS1 server 101 from both ends of the system flow. TRACS1 101 houses an Internal databaseI 10A that receives information through a Data Transformation Services (DTS) package that is run on a daily basis. The Internal databaseI 101A is an internal copy of the External database 103A. Each loan holds as collateral one or more properties. Each property has a loan profile. Each loan profile has general property information, property financial information, property inspection information, contact information and information related interactions with the property.

In the preferred embodiment, at least the following information is included for each loan profile: physical attributes of a property including general property information parameters such as address, city, and nearest Metropolitan Statistical Area (MSA) and American Council of Life Insurers (ACLI) regions. Contact information includes phone numbers (fax, wireless, residential, business) and names of people related to the property (owner, manager tenant). Information related to the interaction with the property includes phone, correspondence, and analysis logs.

The TRACS 1 Server 101 passes all new loan information to the rest of the components of the overall system. Regular downloads of new or additional information concerning loan and property information occurs between the External Server 103 and TRACS1 101. TRACS1 101 also houses an Internal databaseII 101B which houses information passed to it from the TRACS1 101 Internal databaseI 10A and client workstation 105. TRACS2 102 communicates with client workstation 105 through a Distributed Component Object Model connection (DCOM). Although SQL databases are exemplified, in alternative embodiments, other types of relational database may be used, such as an Oracle™ database or any other type of database structure may be utilized.

The TRACS2 backup and reporting server 102 is a data warehouse that houses backup copies of the Internal databases 101A and databaseII 101B. Data from TRACS1 101 is transferred to the databases in TRACS2 102. The transfer of information from the External database 103A to the Internal databases 101A is a process, preferably performed nightly, that completely refreshes the information located in the Internal databaseI 101A. In a preferred embodiment, a Microsoft™ Transaction Server (MTS) 106 transfers the information between Internal databaseII 101B and Internal databaseIV 102B. This is a transactional replication process. A process that is routinely run transfers calculated values from the Internal databaseIV 102B to the Internal databaseV 102C, both located on TRACS2 102. Internal databaseV 102C is a reporting database used to create customized reports. Although the Microsoft™ operating system is exemplified, operating systems such as UNIX or Apple can also be utilized.

The TRACS2 backup and reporting server 102 processes reports about general portfolio management and internal administrative information requested from a standard interface located on the client workstation. Portfolio management reports include financial statements, status reports and collateral reports (monthly, quarterly, semi-annually, annual and quarterly YTD). Portfolio management reports include CMSA surveillance and status reports. CMSA surveillance reports are property financial statement reports and inspection reports. The property financial statement reports comprise all of the CMSA required reports including but not limited to, comparative financial status reports, property file, operating statement analysis reports and NOI adjustment worksheets. The status reports are comprised of delinquent loan status reports, real estate owned (REO) reports and watch list reports. The internal administrative reports are loan management internal reports and portfolio assignment summaries. The loan management internal reports consist of statement inventory reports, exception reports, portfolio assignment summaries, and loan property and contact reports.

In the preferred embodiment, the TRACS2 backup and reporting server 102 handles the generation of operating statements. The operating statements are tracked monthly quarterly, semi-annually and yearly. Properties also have reports based upon the compliance requirements of a loan as specified by individual loan documents. Operating statements are coded by line items that correspond to a general chart of account codes. These codes can be mapped to reports such as Fannie Mae^{SM} or for CMSA reporting purposes.

The TRACS2 backup and reporting server 102 handles the generation of reports based on the level of compliance required for industry standard reports. Transmittal reports from a listing of all the financial statements received on a loan and data entry reports on either a loan basis, portfolio basis or system wide basis are types of reports that can be requested by the client server for generation. Data entry reports list all the loan tracking information contained in the system.

In the preferred embodiment, the client workstations 105 are equipped with Windows 95™ or above, DCOM Win95, MDAC (Microsoft Data Access Components) 2.5 and Microsoft Office 97™ or above. The Internal databaseII 101B is in two-way communication with the client workstation 105. The client workstation 105 can add, modify, delete and send inquiries to the Internal databaseII 101B. The Internal databaseII 101B processes these inquiries sent to it by the client workstation 105 and responds either by displaying the requested information or an error message.

Data contained in the External database 103A changes constantly, as does the data entered into client workstation 105 that is transferred to the Internal databaseI 101B. The other databases are refreshed or updated on a regular basis. Regular users cannot modify data transfers that occur within the two servers TRACS1 101 and TRACS2 102. In an emergency, if the TRACS1 server 101 is not running, it is possible to transfer information from the TRACS2Server 102 back into the TRACS1 Server 101.

The data flow process from the client workstations 105 and the External Server 103 to the TRACS1 Server 101 and TRACS2 Server 102 is illustrated in FIG. 1a. ODBC enables a remote connection between the External Server 103 and TRACS1 Server 101. A user id is defined in ODBC to enable access to the External database 103A located on the External Server 103 as well as enabling the definition for the transfer of data at a step S11.

In step S12, the data from the External database 103A is transferred to the Internal databaseI 10A through a nightly process. Records are extracted and loaded into American Standard Code for Information Interchange (ASCII) files by a BulkCopyProgram (BCP) loading process. This is a complete refresh.

As soon as the transfer takes place between the External database 103A and the Internal databases 101A, a backup facility transfers the data from the Internal databases 101A to another file and restores the data from this file to the Internal databaseIII 102A housed at the TRACS2Server 102 at step S143. This is also a complete refresh process.

At step S14, new information from the Internal databases 101A is transferred to the Internal databaseII 101B. This is an update process.

At step S11, data is transferred through an instantaneous replication process from the TRACS 101 Internal databaseII 101B to the TRACS 102 Internal databaseIV 102B.

Reports may be requested using the client workstation 105 at step S16. This request is sent to the Internal databaseII 101B housed in the TRACS1 Server 101. Because some of the reports are CPU intensive, in the preferred embodiment, TRACS2 102 is configured with at least one processor and RAM. Reports are processed on TRACS2 102 using data from Internal databaseIV 102B. General work is performed on TRACS1 101 and the data is instantaneously replicated between TRACS1 and TRACS2.

In the preferred embodiment, both the TRACS1 server 101 and the TRACS2 server 102 comprise Windows NT™ servers. Each report includes a template for Microsoft Excel™ that includes layouts for the reports. A similar application could also be used. Reports can also be customized using an application such as Crystal Reports™, or another reporting application, using information from the Internal databaseV 102C.

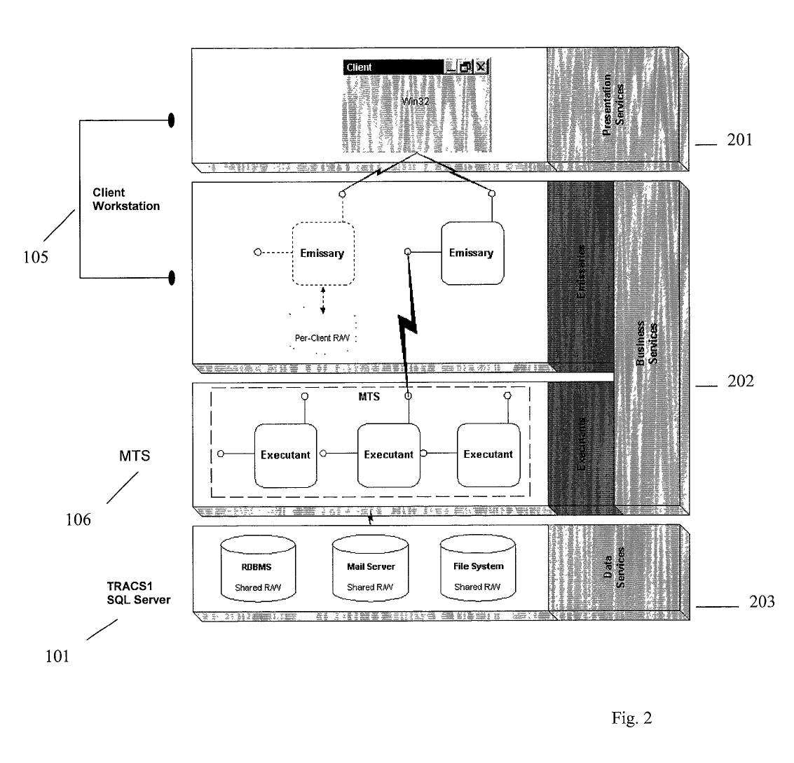

FIG. 2 provides a detailed description of the workflow process in Transaction Server 106 which transfers data between the client workstation 105 and the TRACS1 101 and TRACS2 102 servers. There are three tiers that make up the TRACS™ application architecture: Presentation Services, Business Services, Data Services. Preferably, these three Tiers are based on a Microsoft Windows DNA structure. The functions of the tiers are separated for better scalability and performance of the application.

The Presentation Services Tier 201 is the graphical user interface on the client workstation. The graphical user interface is what the user sees in order to perform modifications, enter/delete information or query a report. Preferably, it is a Visual Basic 32 bit application with eight ActiveX.exe components, although other programming languages such as Java may be utilized. The main roles of this tier are to send user information to the Business Services Tier 202 for processing, receive results from the Business Services Tier 202 processing and to present results to the user.

The Business Services Tier 202 houses objects called emissaries. Emissaries contain all the information about the objects. The emissaries store procedures that bridge the gap between the Presentation Services Tier 201 (client workstation) and Transaction Server 106 components. The emissary pieces run on the client workstation 105 together with the Presentation Services Tier 201. Emissaries are initialized by the Presentation Services Tier 201 and are used to present data on the Presentation Services Tier 201. The emissaries contain the entire hierarchy of the data model. The Business Services Tier 202 is packaged with ActiveX.dll components. The main roles of this tier are to receive input from the Presentation Services Tier 202; validate user input; verify user access rights; interact with the Data Services Tier 203 to perform the business operations that the application was designed to automate (i.e. check property compliance, approve adjustments, etc.); and to send the processed results to the Presentation Services Tier 201.

The Data Services Tier 203 holds a collection of SQL stored procedures that fulfill business service requests. The main roles of the Data Services Tier 203 are the storage of data; retrieval of data; maintenance of data; and to ensure the integrity of data.

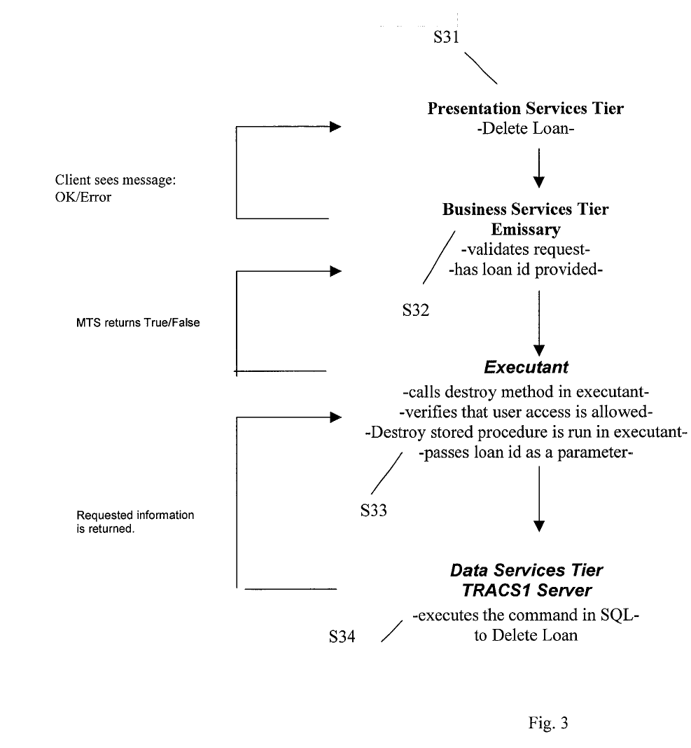

As shown in FIG. 3, the TRACS™ application is structured around the relationship of different objects with various supporting wizards and tools. The term object refers to the way portfolios, loans, properties, and statements are represented in TRACS2 102. Each of these objects are related and dependent upon the other. Once an object has been created, TRACS2 102 stores data relating to that object. All executants used in TRACS1 101 are housed at the Transaction Server 106. Executants verify emissary requests. There are ten components totaling 59 objects in TRACS1 101. The objects are grouped by functionality on the hierarchy. The ten components are all ActiveX.dll files written preferably in Visual Basic. The components contain methods such as invoke, destroy, create and others. The transaction server 106 defines and keeps track of user roles (administrator, portfolio manager, user). It also defines these user roles and enforces system-wide security (permissions, access to portfolios).

The objects are used to bridge the gap between the client workstation and the databases/servers. The user never directly communicates with the database. The executant does this by starting a stored procedure to handle the client query.

For example, the executant flow begins with the user selecting to delete a loan at step S31. The emissary related to this action receives the input (with loan id), validates the request and sends it on to the executant in the Business Services Tier at step S32. The destroy method is called in the executant, but before following through with the destroy method, a verification is made to ensure user access is permitted. If the user is not permitted to delete this specific loan, the value: false is passed back through the emissary communicating with the Presentation Services Tier 201 and an error message is displayed at the client workstation 105. If the user is permitted to delete this specific loan, the value: true is passed back and the action continues. A stored procedure is run in the executant for the parameter including the specific loan id at step S33. This information is passed to the Data Services Tier 203 located in the TRACSI server 101. The command to delete the loan is then executed in SQL. The processed information is sent back to the Business Services Tier 202 executant, which is then sent back to the Presentation Services Tier 201 where the user message is displayed verifying that the action was completed S34.

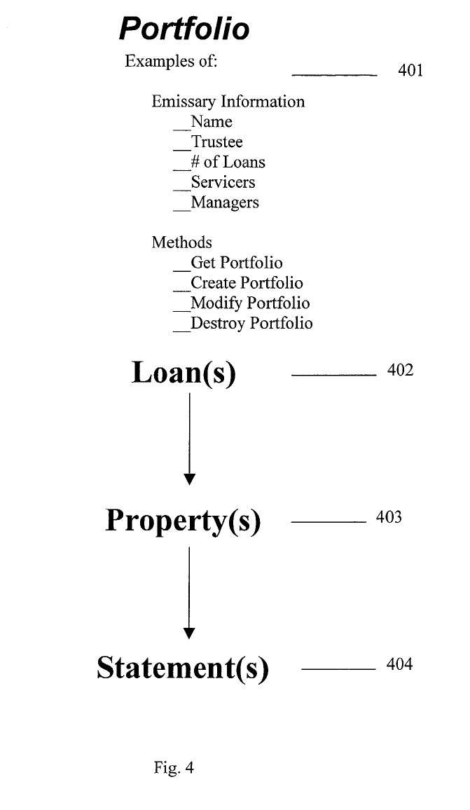

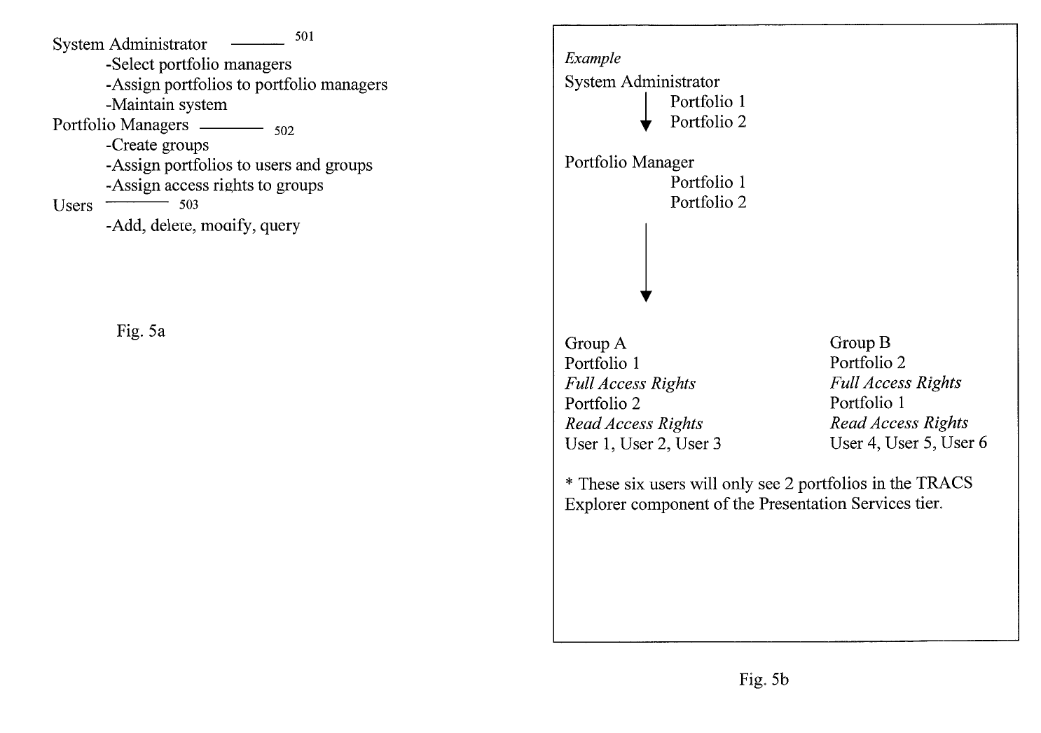

As shown in FIG. 4, there are four main objects in the TRACS™ application. A Portfolio 401 is at the top of the hierarchy. One portfolio contains one or many loans 402. A loan contains one or many properties 403. Each property contains zero or many statements 404. Each of the four main objects contain emissaries. The emissaries contain all the information about the object. For example, the portfolio emissary contains information for the following: name, trustee, number of loans, servicers, and manager. Each emissary for the portfolio also contains methods that execute emissaries' requests.

Referring to FIGS. 5a and 5b, the TRACS™ application maintains a user hierarchy. System administrator 501 is the highest level and may perform all actions associated with the system. The system administrator 501 maintains the system and selects/assigns portfolio managers. Portfolio managers 502 are the next level and may perform actions such as creating groups and assigning portfolios and users, as well as assigning access rights to those groups. Groups are a selected number of users who may work on specific loan, property, and statement information associated with a portfolio. Users 503, the lowest level of the hierarchy, are assigned to groups and portfolios. The user 503 may only access the group and portfolio that has been assigned to them.

For example, in FIG. 5b, the system administrator 501 assigns a portfolio manager and assigns Portfolio 1 and Portfolio 2 to that portfolio manager. The portfolio manager creates Group A and Group B and assigns Portfolio 1 and 2 respectively. Users are also assigned to the respective group. Group A has been assigned Portfolio 1 and Portfolio 2. Users 1, 2, and 3 of Group A have been given full access rights to Portfolio 1 by the portfolio manager and read access rights to Portfolio 2. This means that these users may add, delete, modify and query reports for Portfolio 1 and they may only view the contents of Portfolio 2. Group B has been assigned three users and contains read access rights to Portfolio 1 and full access rights to Portfolio 2. The users of both groups will only see two portfolios when they view the TRACS™ application interface. There are numerous portfolios managed by the TRACS™ application, but users assigned to groups will only be able to see the portfolios to which they have been assigned.

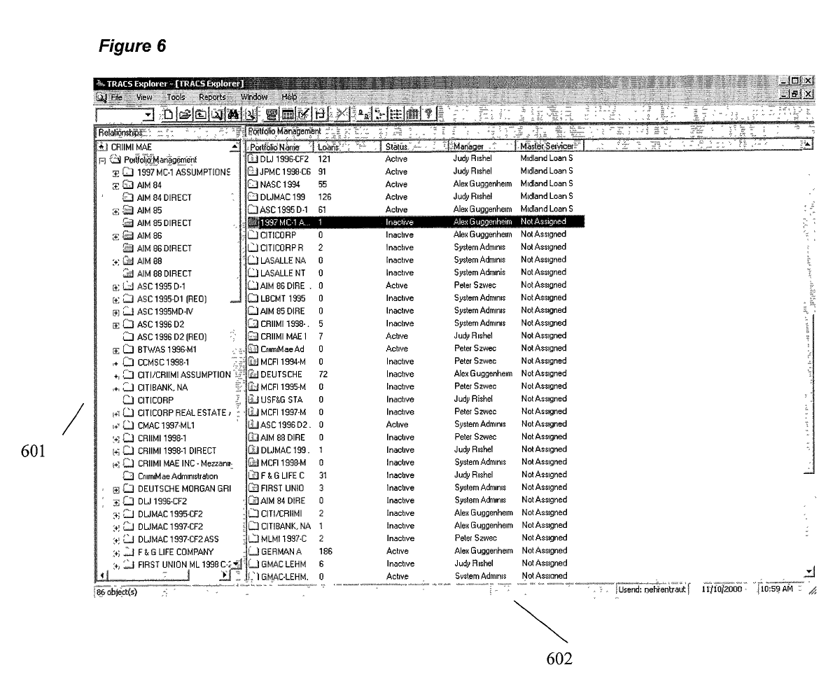

Referring to FIG. 6, this component is the TRACS™ application Explorer component of the Presentation Services Tier 201. The Explorer component is a stand-alone .exe file. All other components are launched from the Explorer component and are ActiveX.exe files programmed in Visual Basic. The Explorer component is the primary method of navigating through the TRACS™ application. It is the main screen that can be used to access all areas and functions of the application. The Explorer component is always open and is the default navigation tool. The Explorer component operates on the same principles of the Microsoft Windows™ Explorer or File Manager. The left pane 601 of the Explorer component displays the path to an object, while the active objects are displayed in the right pane 602. The Explorer component also contains the TRACS menu bar and TRACS toolbar. From the menu bar the user may perform the following options:

File-Enables the user to Open a Loan, Property, Portfolio, or Statement, enter a New Loan, Property or Portfolio and other standard Microsoft commands.

View-Enables the user to display the TRACS viewer, Triggers window and Viewer window upon startup as well as other standard Microsoft commands.

Tools-Enables the user to perform actions or display information. The menu commands are: Find, Check In Document, Assets Under Review, Current Workflow, Trigger and Alerts, Activity Log, Contact Manager, Form Letters, TRACS Viewer, Administrative and Fonts.

Reports-Enables the user to run reports.

Window/Help-Include standard Microsoft commands.

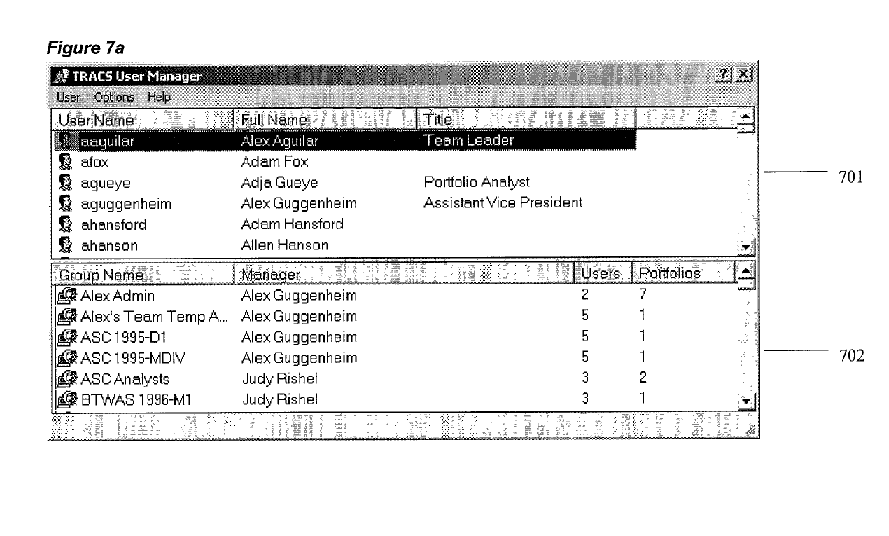

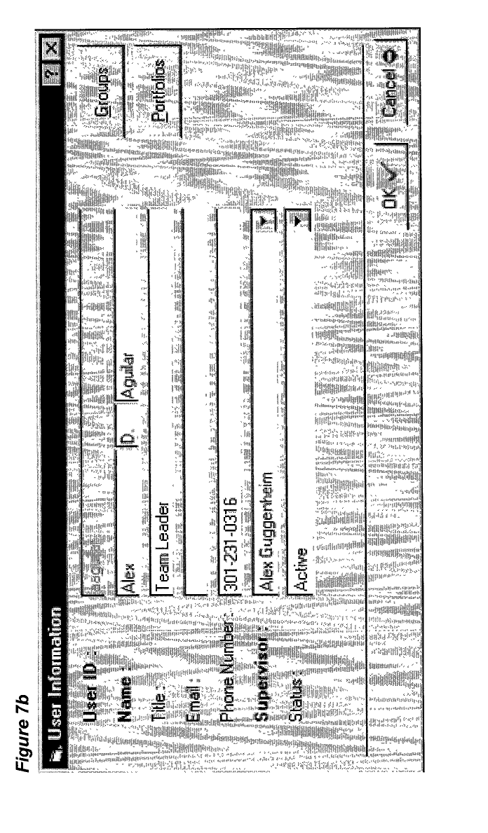

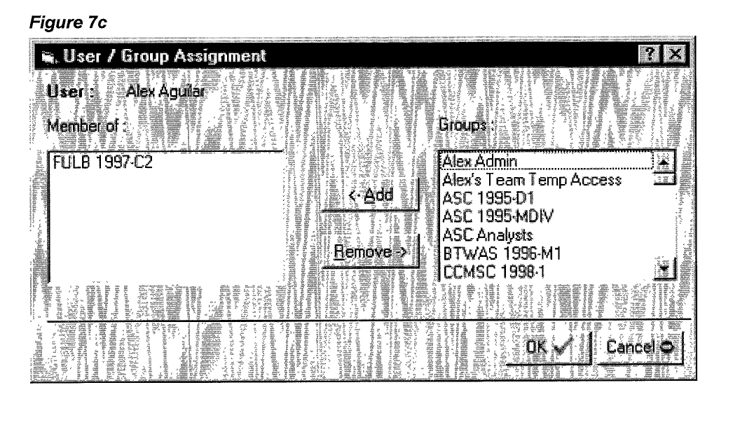

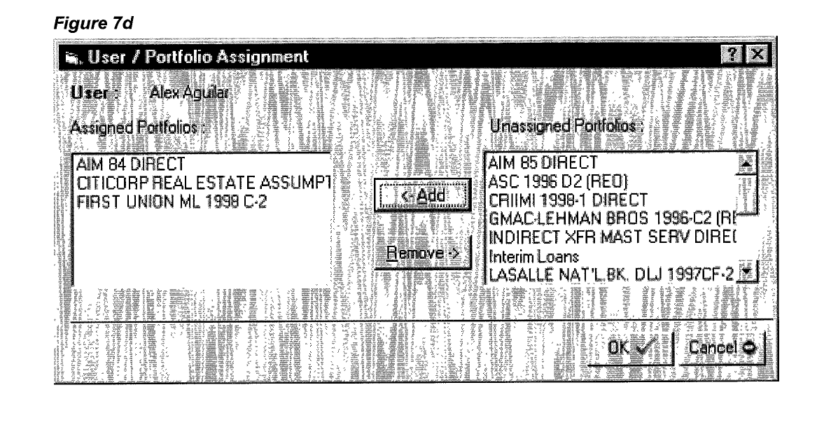

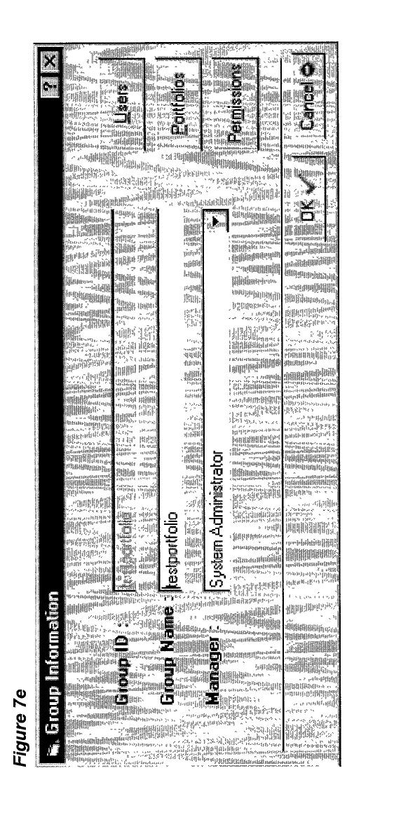

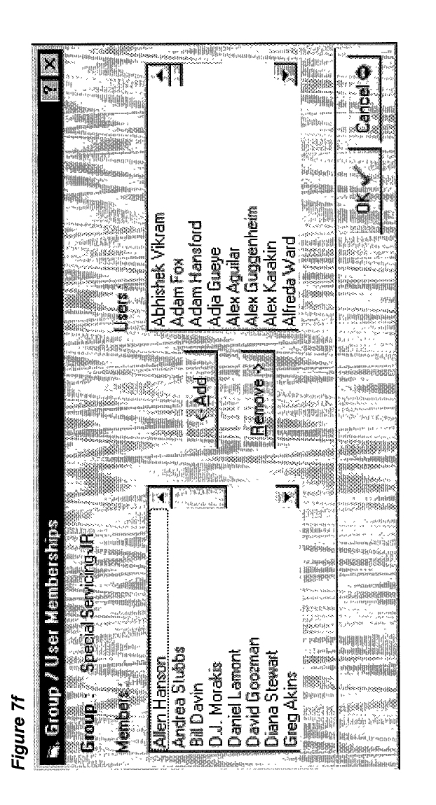

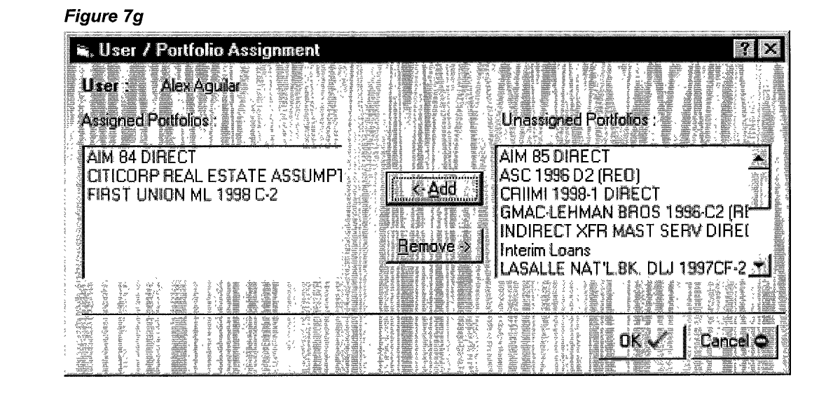

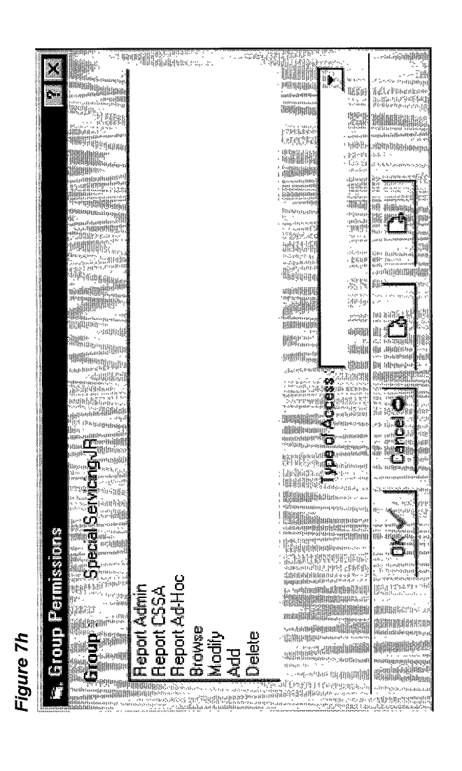

In FIGS. 7a-7g, components of the User Manager component of the Presentation Services Tier 201 are illustrated. In FIG. 7a, the User Manager is an administrative tool used by the system administrator 501 to manage the TRACS™ application login accounts and user profiles. It is also used by portfolio managers to create groups, assign users to the group, assign portfolios to the group, and assign permissions to the group.

The User Manager Form is the default form for the TRACS™ Application User Manager component. The top half of the Form 701 shows a list of all system users. The bottom half of the Form 702 shows a list of all system portfolio groups. As shown in FIG. 7b, the User Information form is used by the system administrator 501 to manage the user status, supervisor, and other personal information. As shown in FIG. 7c, the Groups Form enables the system administrator 501 to add/remove users from portfolio groups. As shown in FIG. 7d, the Portfolios Form enables the system administrator 501 to add/remove portfolios from portfolio managers. As shown in FIG. 7e, the User Manager Form is used by the system administrator 501 and portfolio managers to manage portfolio group information. Portfolio managers can use this form to create groups. The system administrator 501 can also use this form to change group ownership among the various portfolio managers. As shown in FIG. 7f, the Users Form is used by portfolio managers to add/remove users from the group. As shown in FIG. 7g, the Portfolios form is used by portfolio managers to add/remove portfolios from a group created using the User Manager Form. Portfolio managers can only add/remove portfolios that have been assigned to them by a system administrator. As shown in FIG. 7h, the Permission Form is used by portfolio managers to add/remove permission levels from the group. Permission levels range from full access to read only rights.

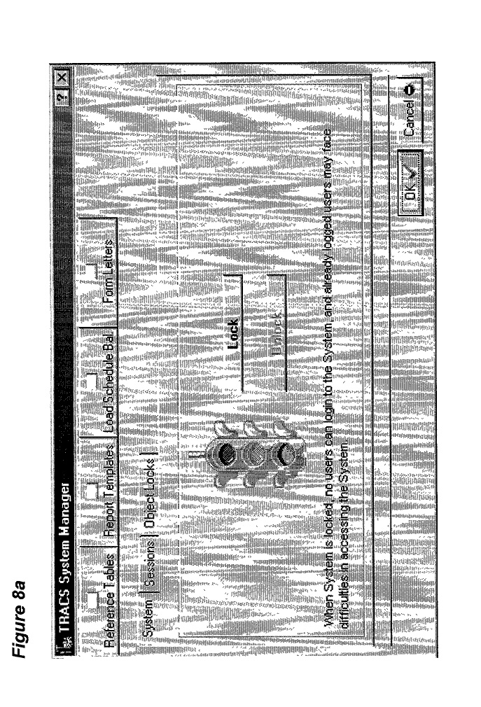

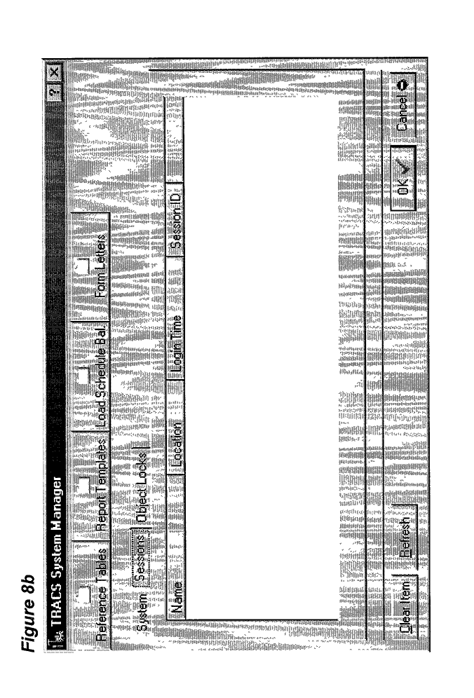

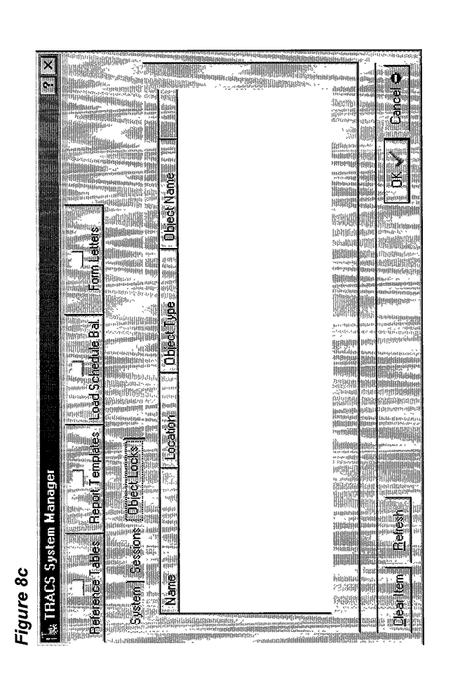

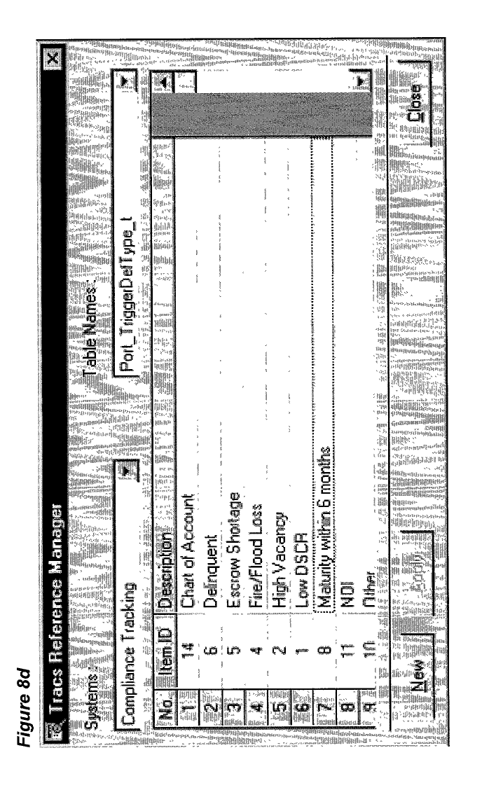

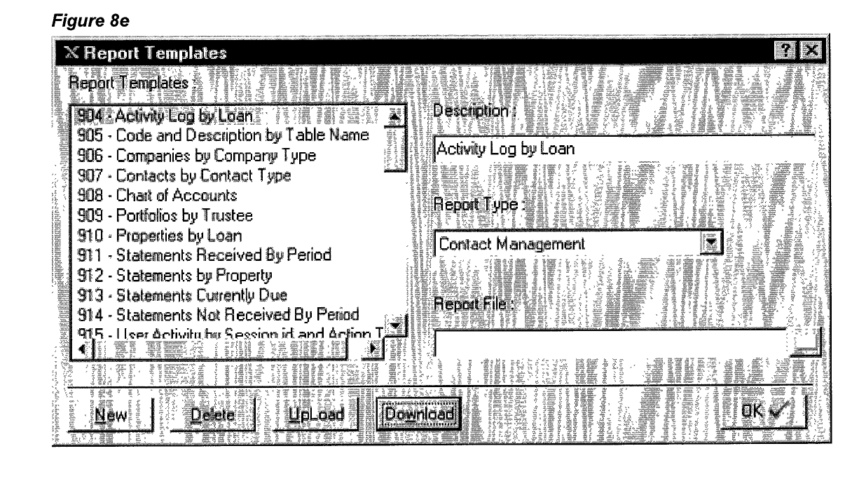

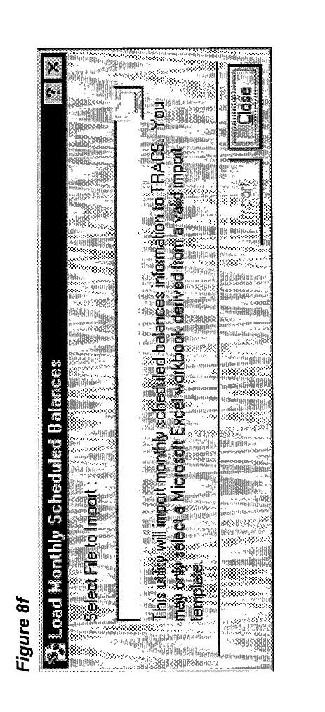

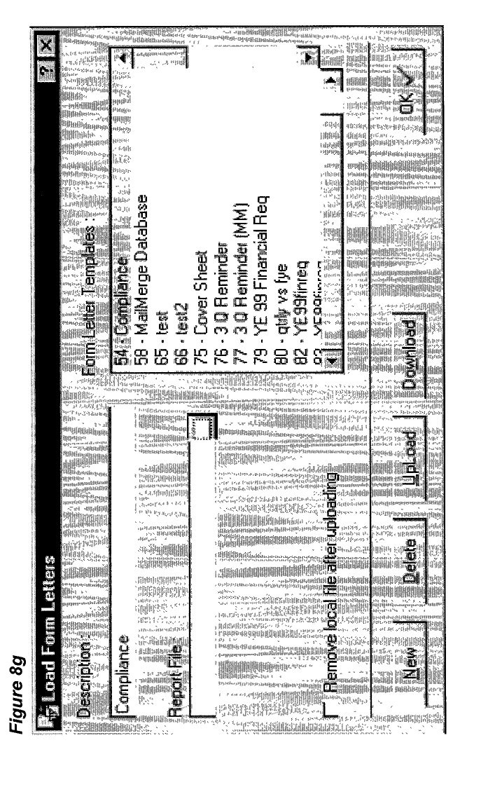

In FIGS. 8a-8g, the System Manager component of the Presentation Services Tier 201 are illustrated. In FIG. 8a, the System Manager is used by the system administrator 501 to manage and maintain the TRACS™ application. This component is a stand-alone.exe file. The default form for the System Manager is the System Status Form. It enables the system administrator 501 to lock the system and prevent users from logging in. As shown in FIG. 8b, the Sessions Form enables the system administrator to view a list of all open sessions. It also enables the system administrator 501 to release/close open sessions when a client workstation 105 failure occurs.

As shown in FIG. 8c, the Object Locks Form is used by the system administrator 501 to manage object locks. Objects may not be modified by more than one person simultaneously. If a client fails to release an object lock, the system administrator 501 can use this form to release the lock and make the object available to other users. As shown in FIG. 8d, the References Form enables the system administrator to add/remove/modify entries in the lookup tables supporting the TRACS™ application. Lookup tables contain options shown in the interface through drop-down lists or menu options.

As shown in FIG. 8e, the Report Templates Form enables the system administrator 501 to load/download report templates from the database. Report templates are Microsoft Excel™ workbooks with custom Visual Basic code programmed to generate the report. All of these reports are listed in the Reports menu, located in the Explorer component. In the preferred embodiment, there are four types of report templates:

Administrative Template-Administrative reports are created by CMSLP for purposes of internal reporting. The purpose of these reports is to track specially serviced and potential default loans.

CMSA Template-CMSA reports track and compare financial information pertaining to loans.

Custom Portfolio Template-Custom portfolios are created to meet specific reporting requirements for loans, properties and other pertinent information.

Specific Templates-Templates included in this format are: Compliance, Portfolio, Reference, Workflow, and Contacts.

As shown in FIG. 8f, the Load Monthly Schedule Form enables the system administrator to load monthly schedule balance files to the database. The file to load must be a Microsoft Excel workbook based on an import template provided by the TRACS™ application. As shown in FIG. 8g, the Form Letters Form enables the system administrator to load/download form letter templates. Form letter templates are Microsoft Word™ templates with mail merge fields mapping to database mail merge tables.

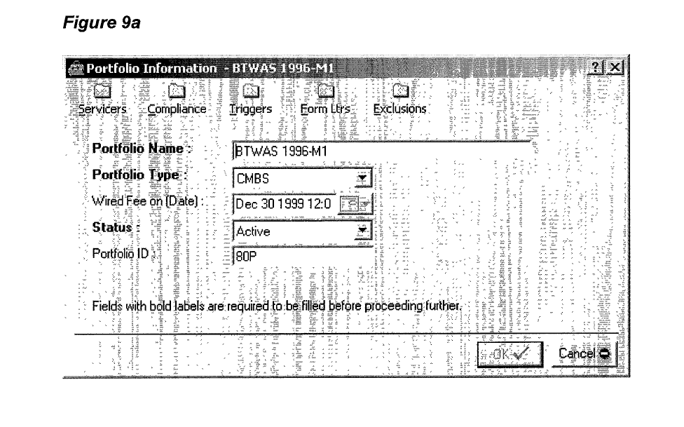

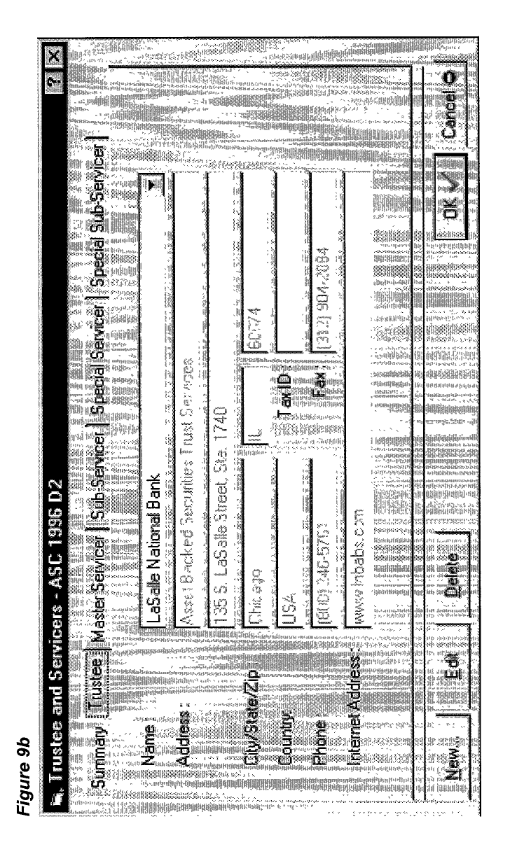

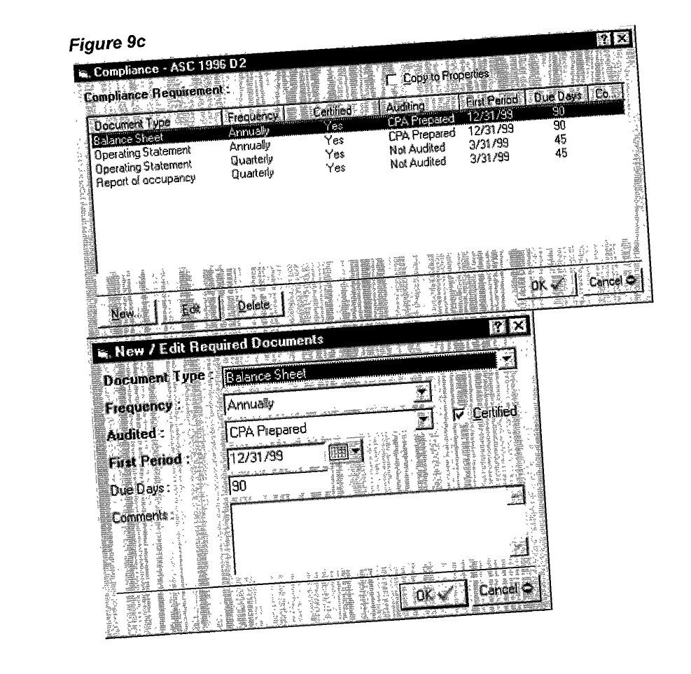

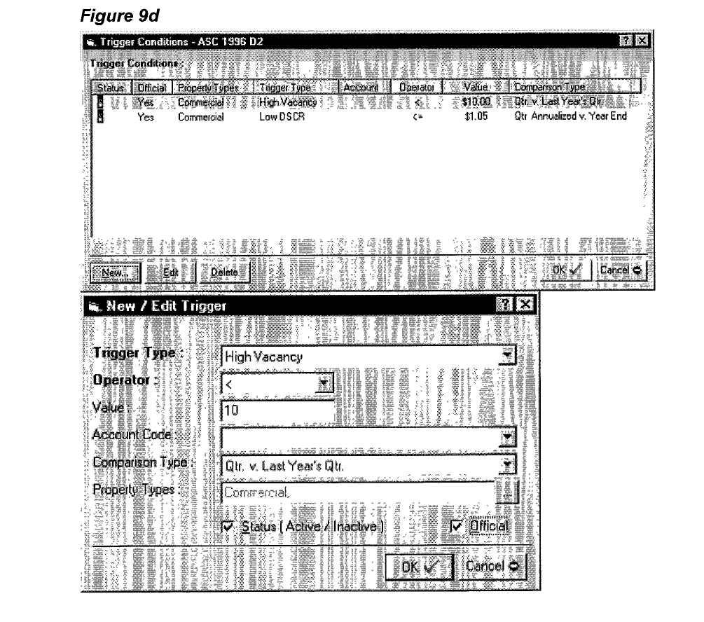

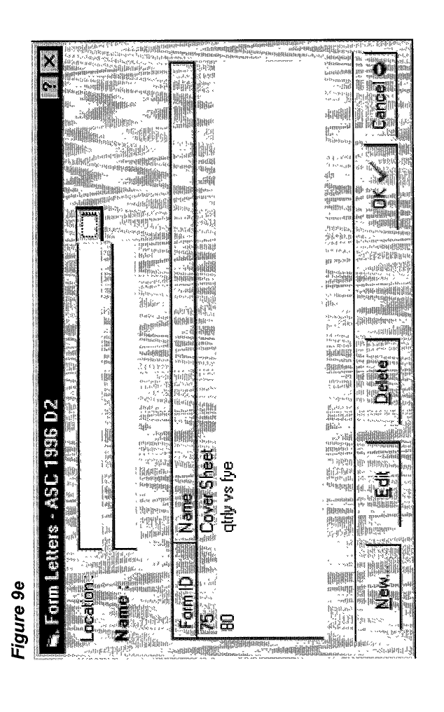

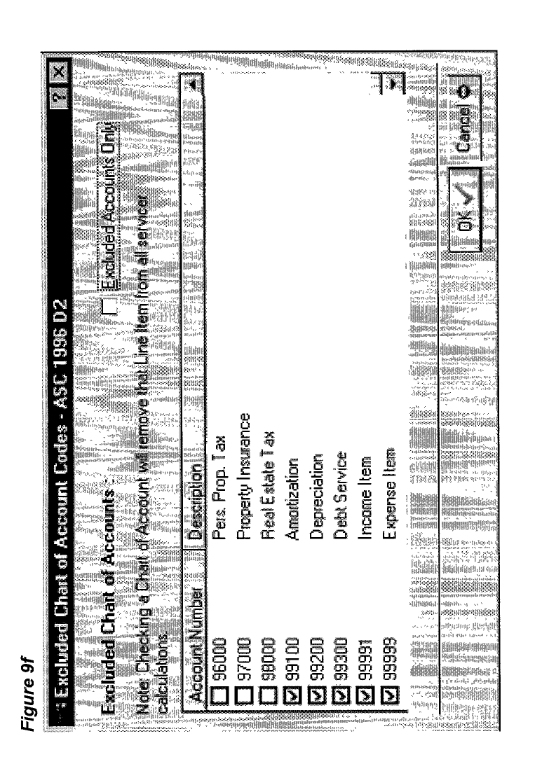

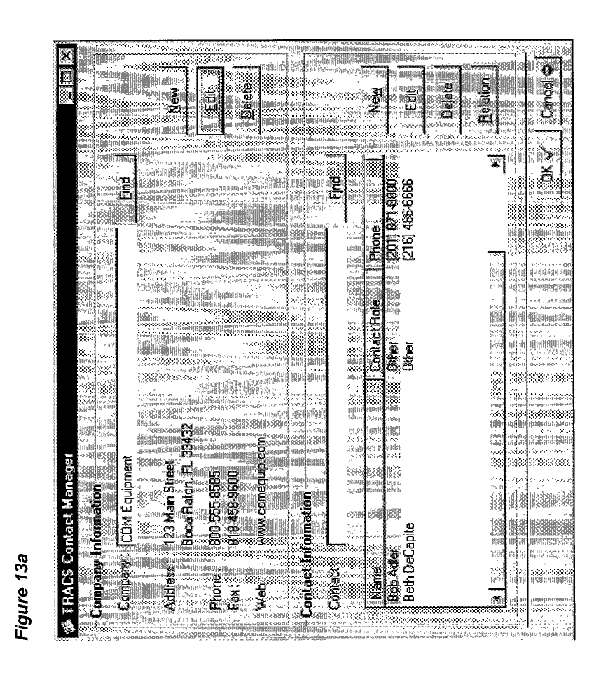

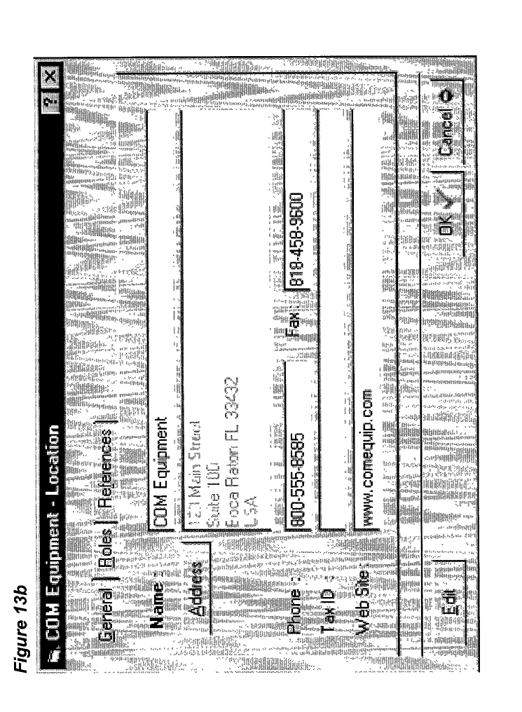

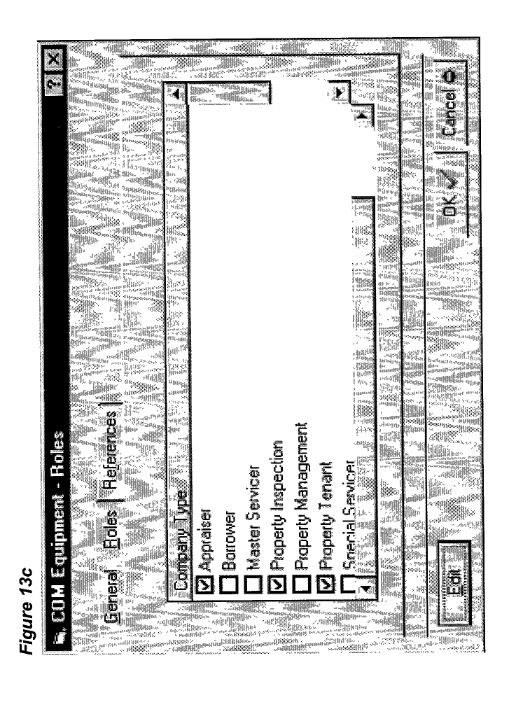

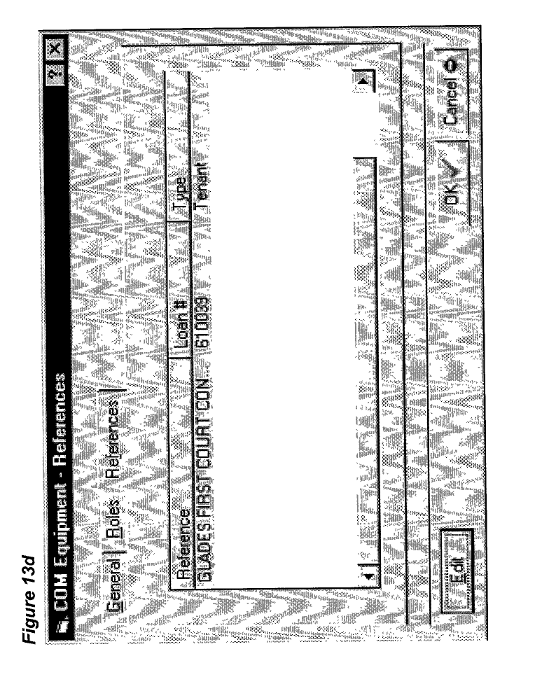

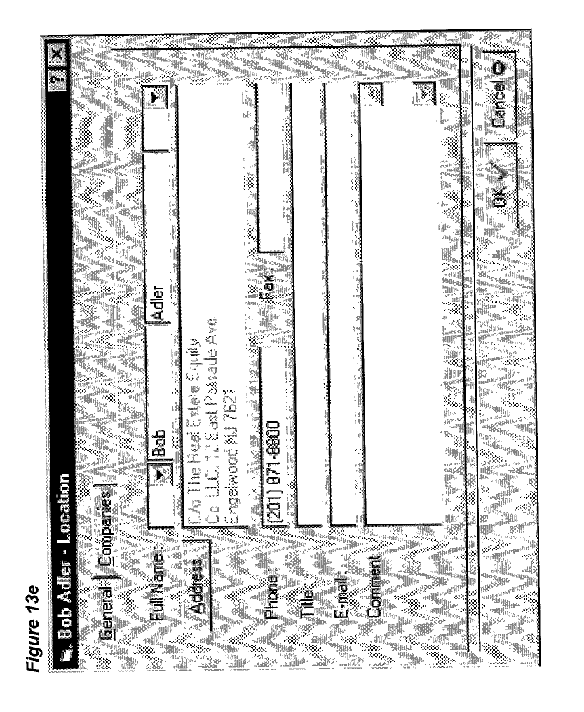

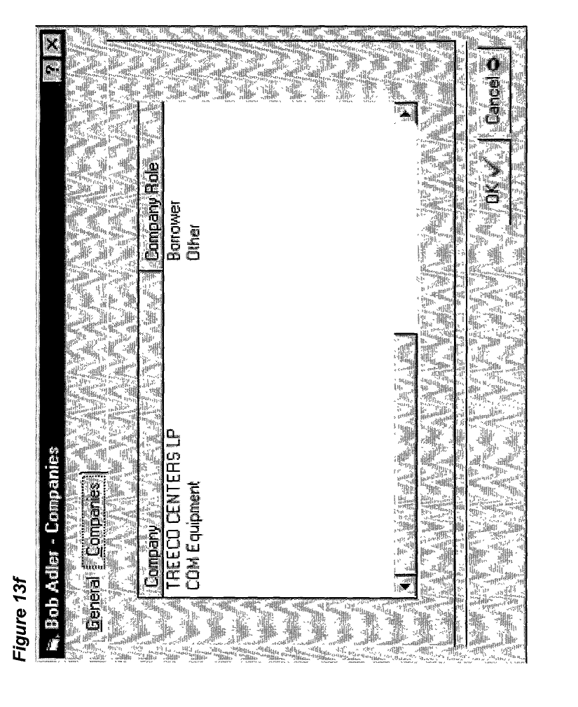

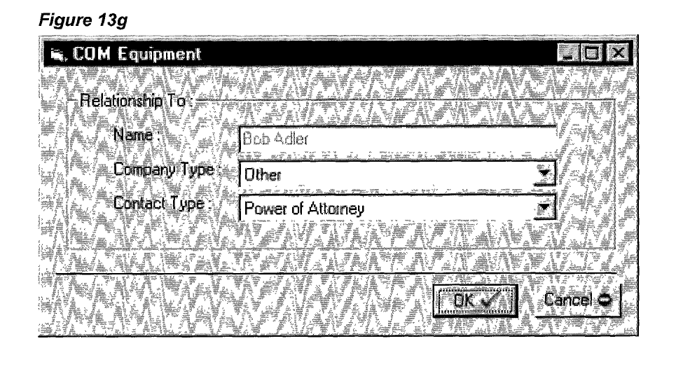

In FIGS. 9a-9f, components of the Portfolio Manager are illustrated. In FIG. 9a, portfolio management houses all data relating to portfolio, loans, properties, and statements in a hierarchy based on the relationship of these objects. As shown in FIG. 9b, the Trustee and Servicers form enables users to assign a trustee to the portfolio and select one or more companies to serve as the master servicer, sub-servicer, special servicer and special sub-servicer. The Contact Manager illustrated in FIG. 13a provides the list of companies to select from. As shown in FIG. 9c, the Compliance Form enables users to select documents that will be expected from all the properties in the portfolio. If any one of these statements is not received by the actual due date, the property and loan will be considered non-compliant.

As shown in FIG. 9d, the Triggers Form enables users to define “trigger” types used to monitor the property's performance. For example, status “Green” indicates that the trigger will be evaluated and status “Red” triggers are considered disabled. Trigger types also cause the loan to be placed in Follow Up status and to further include in administrative reports. As shown in FIG. 9e, the Form Letters Form enables users to load Microsoft Word letter templates to be used in mass mail merge campaigns. As shown in FIG. 9f, the Exclusions Form enables users to select Chart of Account Codes to exclude from calculations used in reports.

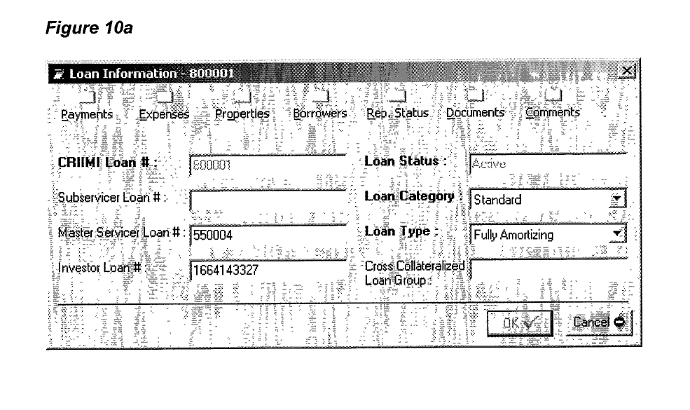

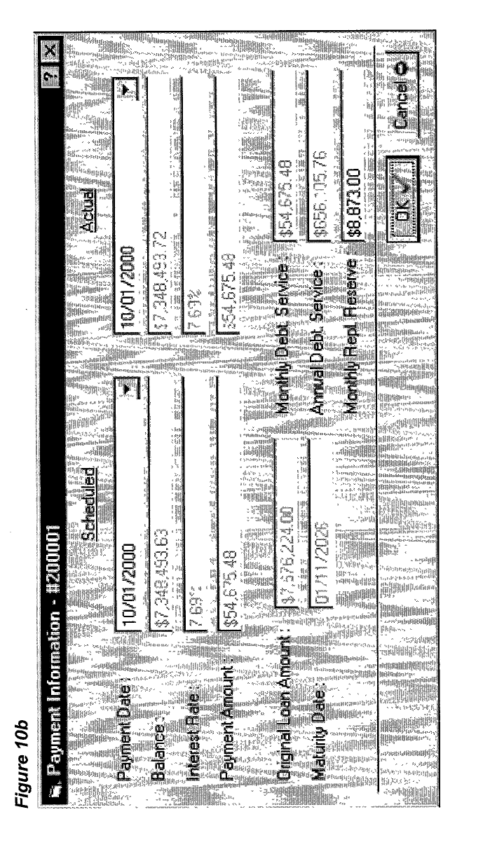

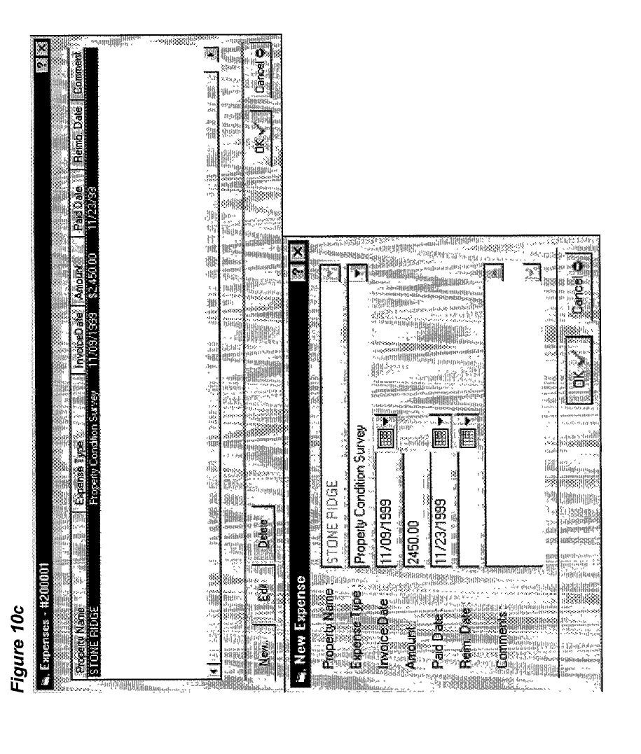

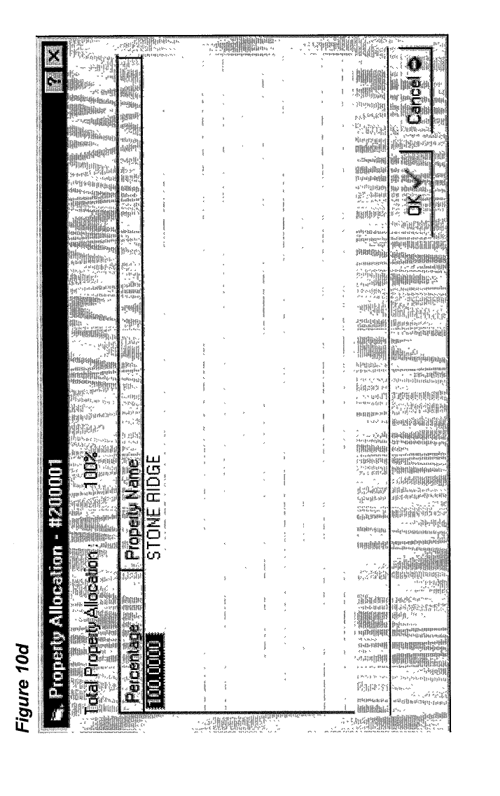

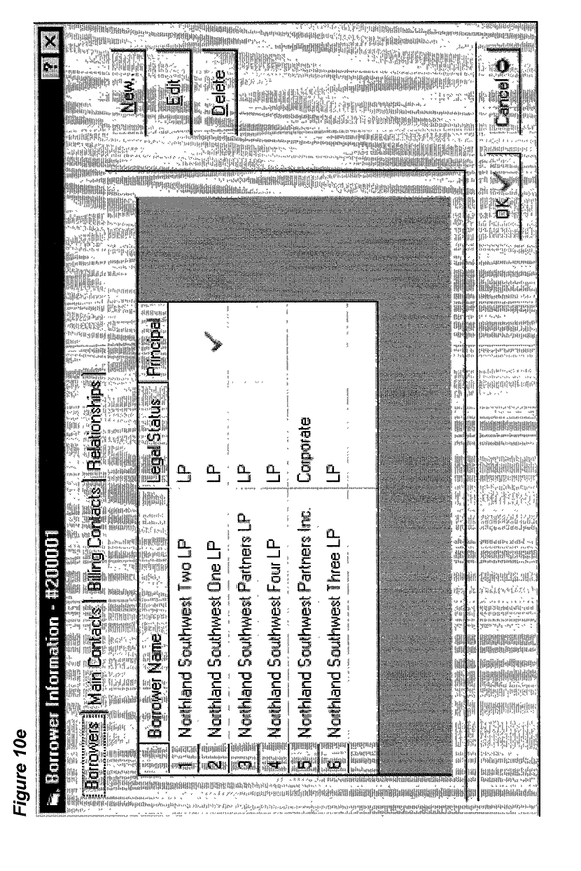

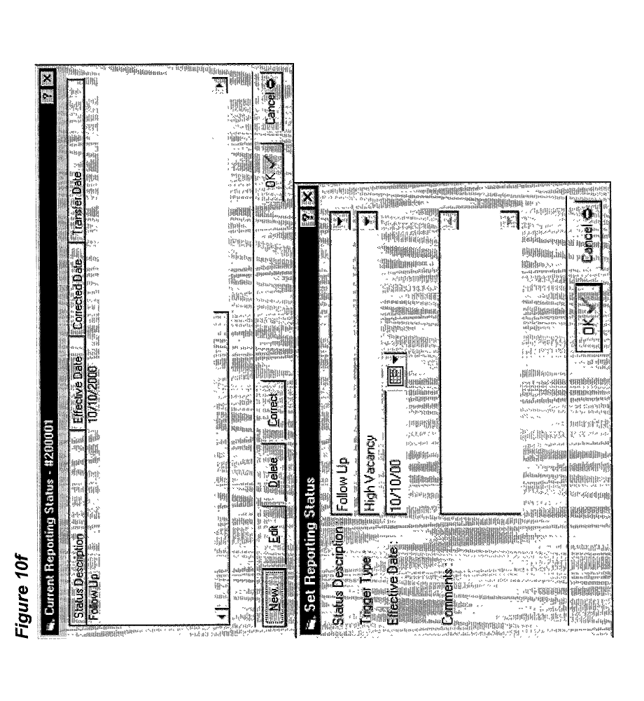

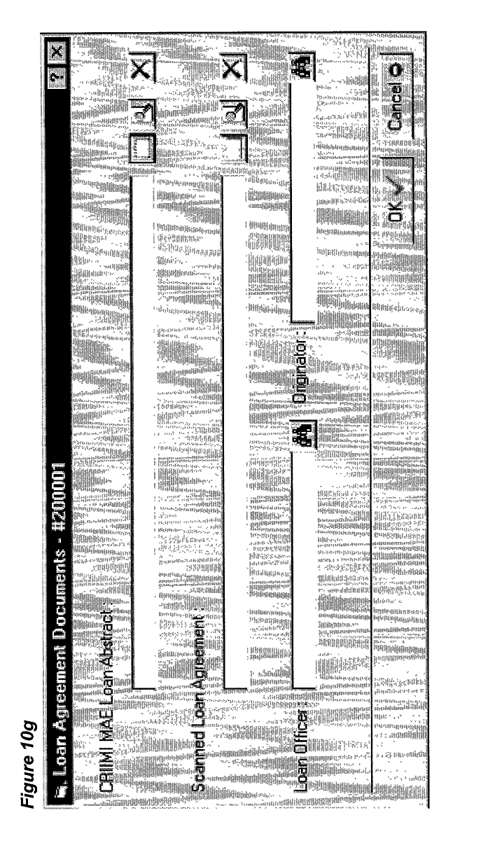

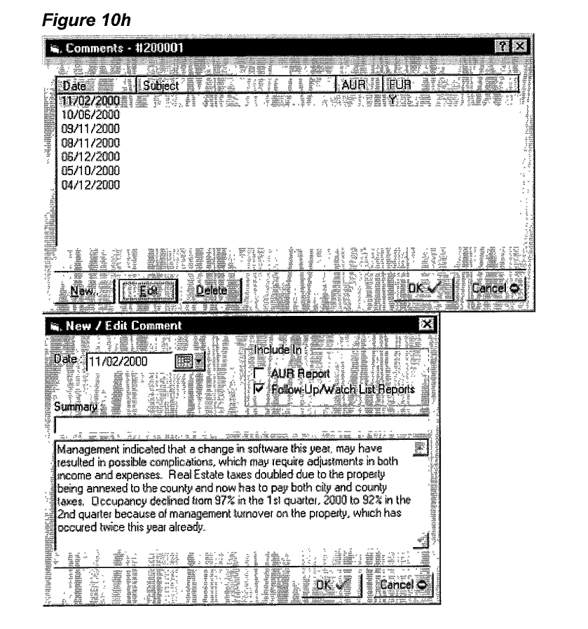

In FIG. 10a-10h components of the Loan Manager are illustrated. In FIG. 10a the Loan Manager provides access to basic loan information and contains icons to access supplemental loan screens containing additional data. The Loan Information Form is the default form of the Loan Manager. This form enables users to assign the loan a unique number to be used internally. Other identifiers are also used such as the loan status, loan category, and loan type. As shown in FIG. 10b, the Payments Form enables users to view historical scheduled and actual loan payments, monthly debt service and replacement reserve payments, and annual amount of debt service. As shown in FIG. 10c, the Expenses Form enables users to enter loan expense information associated with one or all of the properties in the loan. As shown in FIG. 10d, the Properties Form enables users to designate what percentage of the loan will be applied against each of the properties in the loan. For example, total allocation is equal to 100%.

As shown in FIG. 10e, the Borrowers Form enables users to assign borrowers to a particular loan. This form provides an interface to the Contact Manager, illustrated in FIGS. 13a-13g, and facilitates the selection of borrower companies, main contacts, and billing contacts. The “Relationships tab” presents a hierarchical tree of “entity” relationships associated with the loan. It displays the loan signers under each borrower entity. As shown in FIG. 10f, the Reporting Status Form enables users to place and remove loans from various reporting statuses or status codes. Some reporting statuses, such as follow up, cause the loan to be included in administrative reports. As shown in FIG. 10g, the Documents Form enables users to specify the location of the loan abstract document and of the loan agreement image file. The name of the loan officer and loan originator is also selected in this form. As shown in FIG. 10h, the Comments Form enables users to enter general comments associated with the loan. Loan comments may also appear in the Assets Under Review (AUR) administrative report if the AUR Report option is selected. Loan comments appear in the Follow Up Tracking Report and the CMSA Servicer Watch List report if the Follow-Up/Watch List Reports option is selected.

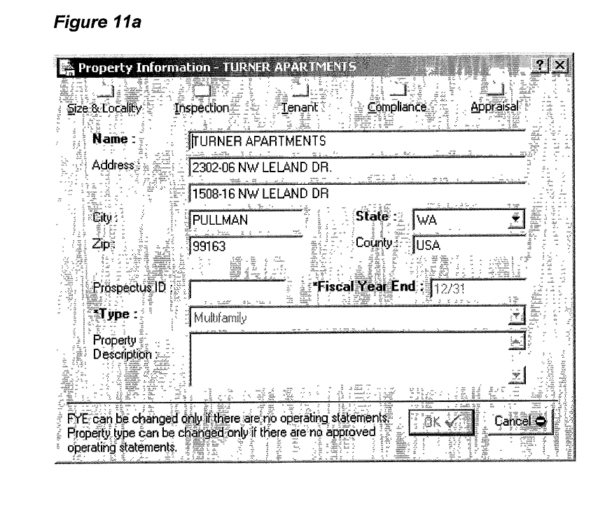

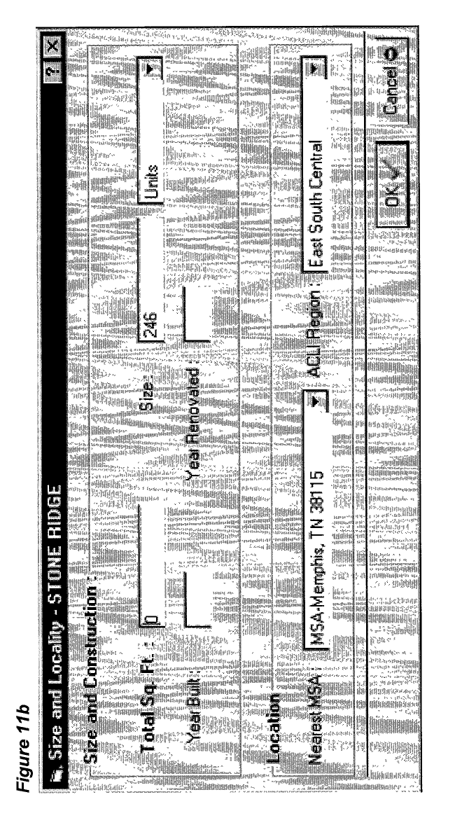

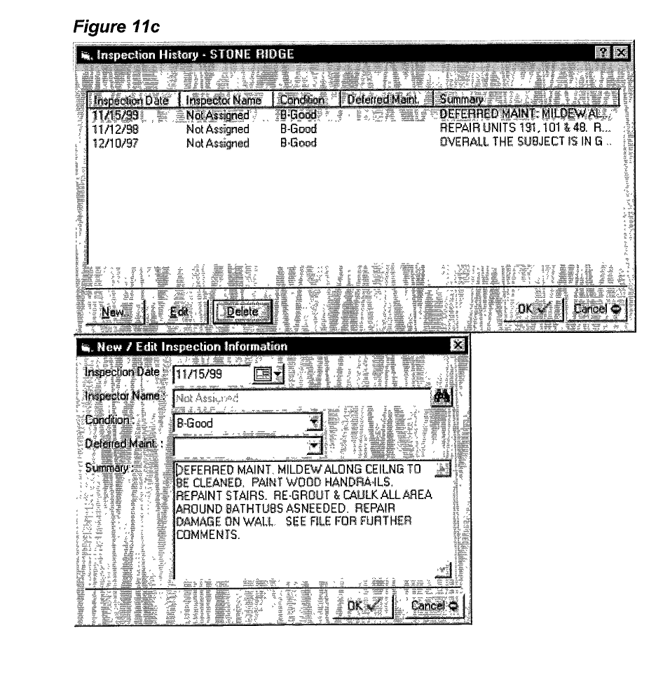

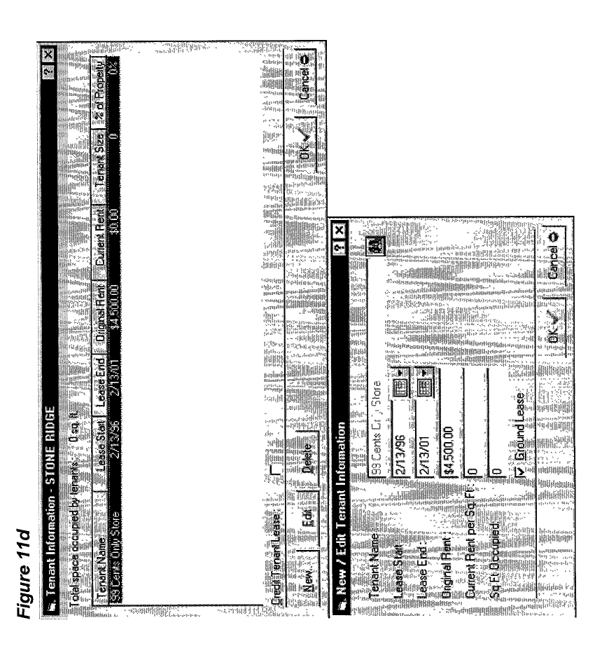

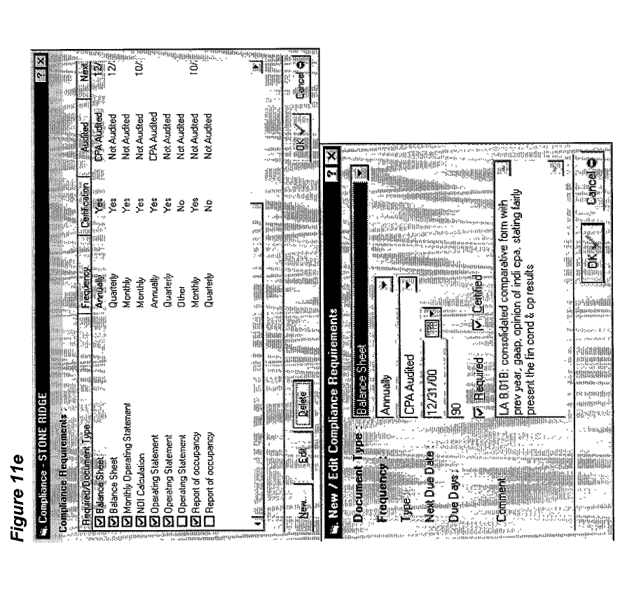

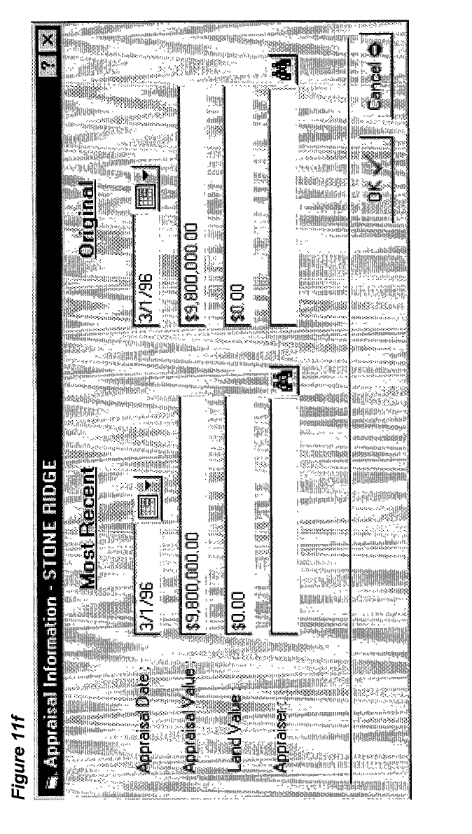

In FIGS. 11a-11f components of the Property Manager are illustrated. In FIG. 11a, the Property Manager refers to the set of screens through which the user can view and edit property level data. This screen provides access to basic property information and contains icons to access supplemental property screens containing additional data. The Property Information Form shown in FIG. 11a is the default form of the Property Manager. This form enables users to enter the property name, location and description. It also enables users to enter the fiscal year end and to select a property type only if the property has no approved operating statements in the database. As shown in FIG. 11b, the Size and Locality Form enables users to specify the total rentable square feet of the property and other relevant measures, such as the number of units. The year the property was built, last year renovated and MSA and ACL region are also assigned using this form. As shown in FIG. 11c, the Inspections Form enables users to enter property inspection information.

As shown in FIG. 11d, the Tenants Form enables users to assign tenants to the property. Tenants are selected from a list of tenants provided through an interface to the Contact Manager illustrated in FIGS. 13a-13g. If the tenant does not exist in the database, the user has the capability to add a new tenant to the database. As shown in FIG. 11e, the Compliance Form enables the user to manage the list of expected statements for this property. Changes made in this form apply only to the current property. The sum of Next Due Date and Due Days determines the actual expected date of the document. If the document is not received by the expected date, the property and loan are considered non-compliant. As shown in FIG. 11f, the Appraisal Form enables users to enter property appraisal information. The appraisal company is selected through an interface with the Contact Manager illustrated in FIGS. 13a-13g.

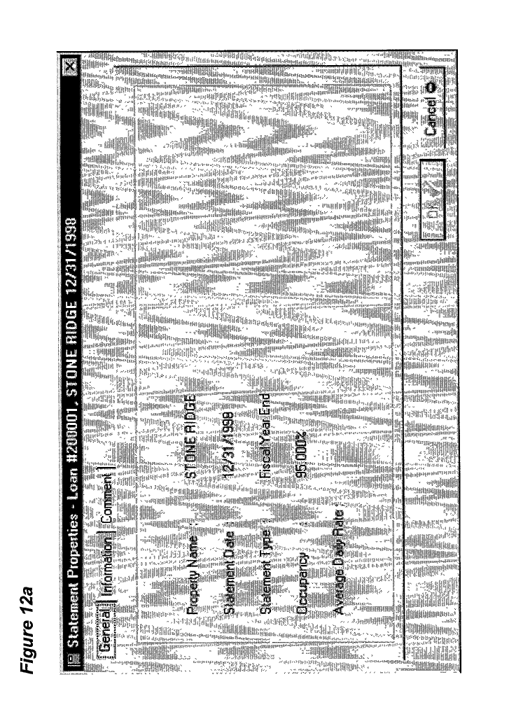

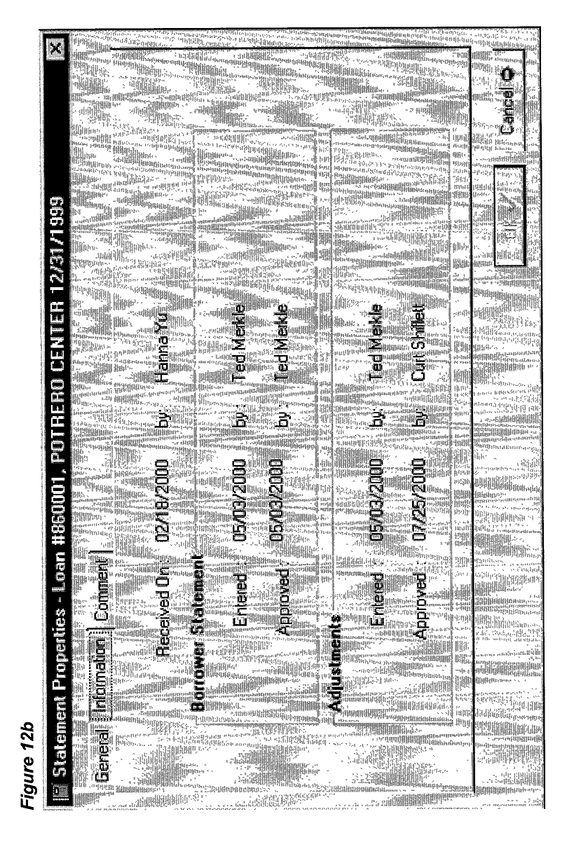

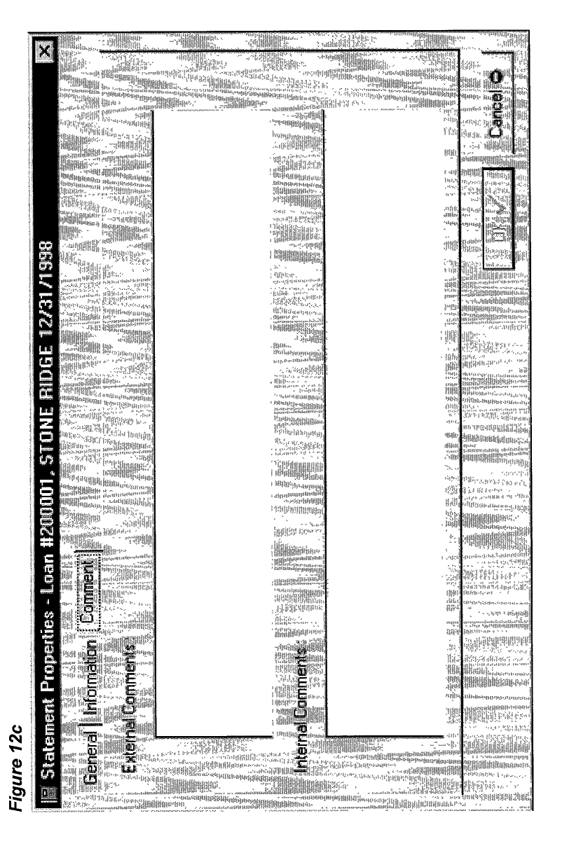

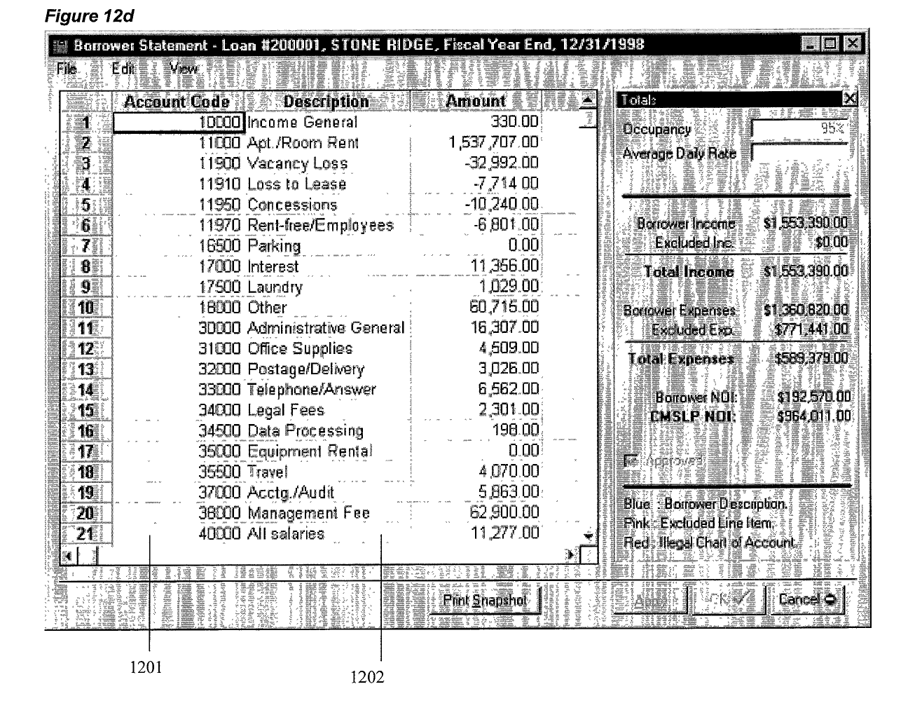

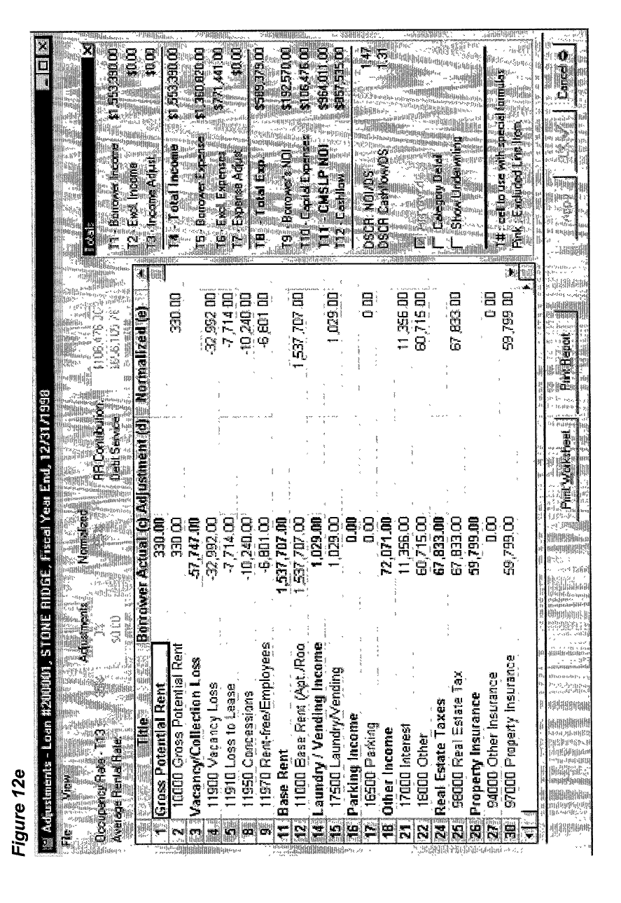

In FIG. 12a-12e components of the Statement Manager are illustrated. In FIG. 12a, statements for properties are managed with the Statement Manager. The default form of the Statement Manager is the General Information Form. Shown in FIG. 12a, this form displays general information about the statement such as the statement date, type, property occupancy and average rental rate. This form is read-only. As shown in FIG. 12b, the Statement Information Form shows the current state of the statement within the workflow process. As shown in FIG. 12c, the Comments Form enables users to enter general comments regarding the statement.

As shown in FIG. 12d, the Borrower Statement Form enables users to enter information as it appears in the borrower statement, enter comments about the borrower statement and assign each statement line the corresponding Chart of Account Codes in column 1201. Line items in column 1202 represent actual borrower descriptions instead of the Chart of Account Code descriptions. As shown in FIG. 12e, the Adjustments Form contains information that represents a summary of the original borrower statement mapped to corresponding Chart of Account Codes and CMSA categories. In the preferred embodiment, this form is designed using the CMSA Net Operating Income (NOI) Adjustment report as a guide. The Adjustments Form enables users to enter adjustments to each of the categories shown and enter adjustments to occupancy and average rental rate, as well as enter comments about each adjustment. Replacement Reserves and Debt Service are automatically calculated but can be adjusted by users as needed.

In FIGS. 13a-13g components of the Contact Manager are illustrated. In FIG. 13a, the Contact Management is equivalent to an electronic address book that contains information pertaining to all companies and their associated personnel. This “address book” tracks all companies that are associated with portfolios, loans or properties in the TRACS™ application. Employees within each company may be assigned roles (i.e. CFO, billing contact, inspection, etc.) that are conveniently organized in a manner that allow quick access to commonly needed information. This information can be searched, printed in form letters and cross-referenced to other loans/properties in an expedient manner.

The default form for the Contact Manager is the Contact Manager Form. It enables the user to search for companies/contacts, add, modify, delete companies/contacts, and associate companies, and contacts based on defined roles. As shown in FIG. 13b, the Company Location Form enables users to edit company location information, phone and fax numbers, and the Uniform Resource Locator (URL) of the company's web site. As shown in FIG. 13c, the Roles Form enables users to assign roles to companies. Roles are used throughout the system to populate the various company lookup lists. As shown in FIG. 13d, the References Form enables users to edit objects referencing the current company. The object to edit is determined by the “Type” column. As shown in FIG. 13e, the Location Form II enables users to edit contact name and location information, phone and fax numbers, and email addresses. As shown in FIG. 13f, the Companies Form enables users to view a list of companies associated with the current contact. This form is a read-only form. As shown in FIG. 13g, the Relationship Form enables users to define the relationship between a company and a contact. The company type options are determined by the roles assigned to the company.

The TRACS™ application could also be utilized to collect payments, real estate taxes or maintain escrow accounts or the TRACS™ application could also monitor other loans that the borrower has.

As can be seen from the foregoing, the present invention provides a financial information management system and business process that streamlines the way information is entered and retrieved. The present invention simplifies the process for entering loan information in order to establish the relationship between properties, borrowers and loans, property financial statements, tracking property financial statements and producing reports. The novel workflow based application is tailored to the needs of property servicing of commercial loans. The TRACS™ application is used to perform a variety of duties related to the surveillance, analysis, and reporting of loans secured by commercial real estate. In the preferred embodiment, the TRACS™ application performs tracking, reporting, analysis of collateral property operating statements, site inspections, and corresponding loan and borrower performance. The TRACS™ application can also perform an analysis of multiple properties across different portfolios, geographic regions, and property types. The TRACS™ application is an effective tool for managing portfolio risk and collecting data for the underwriting on new originations and acquisitions.

It should be appreciated that the present invention is not limited to the particular embodiment(s) described above and illustrated in the accompanying drawings. It is intended that the invention described above in connection with various exemplary embodiments covers all alternatives, modifications and equivalents falling within the scope and spirit of the invention defined by the appended claims.

What is claimed is:

1. A system for managing loan collateral comprising:
a database server housing the loan collateral data;
an application server containing the loan collateral loan profile information, the application server is in communication with the database server;
a reporting server containing application server backup information;
at least one client workstation in communication with the application server; and wherein the loan collateral data is used in developing the loan collateral loan profile information.

2. The system of claim 1 wherein said loan collateral is selected from the group consisting of commercial property, multi-family property, non-commercial property and single family property.

3. The system of claim 1 wherein the database server, the application server and the reporting server are comprised of SQL relational databases.

4. The system of claim 3 wherein the application server is further comprised of two separate databases.

5. The system of claim 3 wherein the reporting server is further comprised of three independent databases.

6. The system of claim 1 wherein the loan profile information includes physical attributes of a property including general property information parameters.

7. The system of claim 6 wherein the loan profile information is selected from the group consisting of operating statement data, borrower contact information, property inspection data, special servicing and assumption data, reserve processing data, property financial data, contact data and data relating to interaction with the property.

8. The system of claim 7 wherein the contact information includes telephone numbers and names of persons related to the property.

9. The system of claim 1 wherein the reporting server generates reports that support the CMSA reporting requirements.

10. The system of claim 1 wherein the client workstations are in two-way communication with the application server.

11. The system of claim 1 wherein the reporting server is in two-way communication with the client workstation.

12. A method of tracking a real estate asset comprising the steps of:
maintaining a database server having the real estate asset loan data;
providing an application server containing the real estate asset loan profile information, the real estate asset data is used to develop the real estate asset loan profile information;
providing a reporting server containing application server backup information;
providing at least one client workstation in communication with the application server; and wherein the application server is in communication with the database server.

13. The method of claim 12 wherein the real estate asset is selected from the group consisting of commercial property, multi-family property, non-commercial property and single family property.

14. The method of claim 12 wherein the database server, the application server and reporting server are comprised of SQL relational databases.

15. The method of claim 14 wherein the application server is further comprised of two separate databases.

16. The method of claim 14 wherein the reporting server is further comprised of three independent databases.

17. The method of claim 12 wherein the loan profile information includes physical attributes of the real estate asset including general property information parameters.

18. The method of claim 17 wherein the loan profile information is selected from the group consisting of operating statement data, borrower contact information, property inspection data, special servicing and assumption data, reserve processing data, property financial data, contact data and data relating to interaction with the property.

19. The method of claim 18 wherein the contact information includes telephone numbers and names of persons related to the property.

20. The method of claim 12 wherein the reporting server generates reports that support the CMSA reporting requirements.

21. The method of claim 12 wherein the client workstations are in two-way communication with the application server.

22. The method of claim 12 wherein the reporting server is in two-way communication with the client workstation.

23. A method of performing analysis and reporting of a loan portfolio secured by commercial real estate comprising the steps of:
accessing a main application screen;
creating the loan portfolio compliance requirements;
monitoring the loan portfolio compliance requirements;
defining a trigger type to monitor the commercial real estate's performance;
creating the loan portfolio financial statement;
tracking data relating to specially serviced loan portfolios;
maintaining a history of the commercial real estate's property inspections;
tracking the commercial real estate's tenant information; and
generating reports pertaining to the loan portfolio.

24. The method of claim 23 wherein the step of monitoring the loan profile compliance requirements comprises ensuring a borrower's adherence to terms set forth in the loan.

25. The method of claim 23 wherein the step of monitoring the loan profile compliance requirements comprises tracking, analyzing and processing documents that a borrower is required to submit to a loan lender.

26. The method of claim 23 wherein the trigger type is a system trigger.

27. The method of claim 23 wherein the trigger type is a portfolio trigger.

28. The method of claim 26 wherein the system trigger is used to identify loan portfolios that fulfill set criteria.

29. The method of claim 27 wherein the portfolio trigger are set to monitor financial performance of the loan portfolio.

30. The method of claim 23 wherein maintaining the history of property inspections includes tracking the inspection date, the inspector's name, the property's condition and deferred maintenance information.

31. A method of tracking a real estate asset comprising the steps of:
assigning a loan portfolio manager;
assigning a loan portfolio to the portfolio manager;
creating a user group;
assigning loan portfolio access rights to users in the user group;
requesting the loan portfolio;
validating the loan portfolio request;
verifying that the user has the right to access the requested loan portfolio;
executing the request; and
wherein the user only has access rights to the portfolio assigned to their group.
